(19) United States
(12) Patent Application Publication
(10) Pub. No.: US 2007/0041407 A1
(43) Pub. Date: Feb. 22, 2007

(54) Method and system for transmission and reception, method and apparatus for transmission, and method and apparatus for reception, and program

(75) Inventor: Yoshiyuki Suzuki, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/499,685

(22) Filed: Aug. 7, 2006

(30) Foreign Application Priority Data
Aug. 16, 2005 (JP) 2005-235642

(51) Int. Cl. H04J 3/12; H04J 3/04

(52) U.S. Cl. 370/522; 370/535

(57) ABSTRACT

A transmission and reception system includes a transmitter for transmitting stream data into which first metadata and second metadata are multiplexed, and a receiver for receiving the stream data transmitted by the transmitter and extracting the first metadata and the second metadata from the stream data. The transmitter includes a multiplexing condition storage unit, a multiplex determination unit, a multiplexing unit and a transmitting unit. The receiver includes a receiving unit, an extraction condition storage unit, an extraction determination unit and an extracting unit.

### CROSS REFERENCES TO RELATED APPLICATIONS

The present invention contains subject matter related to Japanese Patent Application JP 2005-235642 filed in the Japanese Patent Office on Aug. 16, 2005, the entire contents of which are incorporated herein by reference.

### BACKGROUND OF THE INVENTION

1. Field of the Invention

The present invention relates to a system and method for transmission and reception, an apparatus and method for transmission, an apparatus and method for reception and a program, and, in particular, to a system and method for transmission and reception, an apparatus and method for transmission, an apparatus and method for reception and a program for reducing the usage rate of a logic portion of a multiplexer for multiplexing metadata and an extractor for extracting the metadata and for permitting an efficient layout.

2. Description of the Related Art

Japanese Unexamined Patent Application Publication No. 2003-143548 discloses a transmitter for transmitting serial data. The disclosed transmitter for transmitting an HD_SDI signal multiplexes metadata (such as time code) with video data before transmitting the video data. The HD_SDI signal contains as a plurality of conditions for multiplexing the metadata (hereinafter referred to as multiplexing condition), condition indicating whether it is in H_Blanking period (H_ANC), condition indicating whether it is in V_Blanking period (V_ANC), and condition indicating what line the signal is to be inserted. In such a known transmitter, each portion of the signals to be multiplexed is determined as to whether the portion satisfies a variety of conditions, and if it is determined that the portion is determined as satisfying the conditions, the metadata is multiplexed.

To perform such a determination process with a limited number of logic circuits such as field programmable gate arrays (FPGAs), data indicating the variety of multiplexing conditions (hereinafter referred to as multiplexing condition data) is conventionally stored in registers.

More specifically, FIG. 1 illustrates a portion of for multiplexing metadata (hereinafter referred to as meta multiplexer) of a known transmitter for transmitting the HD_SDI signal.

As shown in FIG. 1, information (to be transmitted or to be received) is represented by arrow-headed solid line, and other information such as control information is represented by arrow-headed broken line. The meaning of the arrow-headed solid lines and the arrow-headed broken line is true of the other drawings.

A meta multiplexer in the known transmitter of FIG. 1 multiplexes metadata with a predetermined input signal, and then outputs (transmits) the resulting signal as a transmission signal. The meta multiplexer in the transmitter includes register 1 through multiplexer 5.

The register 1 stores a variety of multiplexing condition data and a variety of target data to be multiplexed, such as metadata. More specifically, H_ANC/V_ANC period as one type of the multiplexing condition data is stored onto registers 1-1 through 1-4 on a condition by condition basis, and Line_Number as another type of the multiplexing condition data is stored onto registers 1-5 through 1-8 on a condition by condition basis. DIDs (Data IDs) as one type of the data to be multiplexed are stored onto registers 1-9 through 1-12 on a condition by condition basis, SDIDs (secondary Data IDs) as another type of the data to be multiplexed are stored onto registers 1-13 through 1-16 on a condition by condition basis, and metadata as another type of the data to be multiplexed is stored onto registers 1-17 through 1-20 on a condition by condition basis.

Two types of multiplexing condition data stored on registers in column (in a vertical direction) in FIG. 1 are considered to be paired in a set (hereinafter referred to as multiplexing condition set). If the H_ANC/V_ANC period and the Line_Number match a set of data, that multiplexing condition is determined as being satisfied.

More specifically, there are two registers 1-1 and 1-5 storing the multiplexing condition set at a first column (hereinafter referred to as first multiplexing condition set). The register 1-1 stores the H_ANC/V_ANC period (as labeled “H1” in FIG. 1), and the register 1-5 stores the Line_Number (as labeled “L1” in FIG. 1).

Similarly, as shown in FIG. 1, there are two registers 1-2 and 1-6 storing the multiplexing condition set at a second column (hereinafter referred to as second multiplexing condition set). The register 1-2 stores the H_ANC/V_ANC period (as labeled “H2” in FIG. 1) and the register 1-6 stores the Line_Number (labeled “L2” in FIG. 1).

Similarly, as shown in FIG. 1, there are two registers 1-3 and 1-7 storing the multiplexing condition set at a third column (hereinafter referred to as third multiplexing condition set). The register 1-3 stores the H_ANC/V_ANC period (as labeled “H3” in FIG. 1), and the register 1-7 stores the Line_Number (as labeled “L3” in FIG. 1).

Similarly, as shown in FIG. 1, there are two registers 1-4 and 1-8 storing the multiplexing condition set at a fourth column (hereinafter referred to as fourth multiplexing condition set). The register 1-4 stores the H_ANC/V_ANC period (as labeled “H4” in FIG. 1) and the register 1-8 stores the Line_Number (as labeled “L4” in FIG. 1).

As shown in FIG. 1, three types of data stored in three registers in column (vertical line) in FIG. 1 are arranged in a set. If a predetermined portion of the input signal satisfies a k-th set of multiplexing conditions (k is an integer number from 1 through 4), the k-th set to be multiplexed (with the left-most column being the first) is multiplexed with the predetermined portion of the input signal.

More specifically, there is a set to be multiplexed at a first column as shown in FIG. 1 (referred to as a first multiplex set). The first multiplex set contains DID (hereinafter referred to as “D1” in FIG. 1) stored on the register 1-9, SDID (referred to as “S1” in FIG. 1) stored on the register 1-13, and the metadata (referred to as “M1”) on the register 1-17. If a predetermined portion of the input signal satisfies the first set of multiplexing conditions, the first set of multiplexing conditions is multiplexed with the predetermined portion.

Similarly, there is a set to be multiplexed at a second column as shown in FIG. 1 (referred to as a second multiplex set). The second multiplex set contains DID (referred to as “D2” in FIG. 1) stored on the register 1-10, SDID (referred to as “S2” in FIG. 1) stored on the register 1-14, and the metadata (referred to as “M2”) on the register 1-18. If a predetermined portion of the input signal satisfies the second set of multiplexing conditions, the second set of multiplexing conditions is multiplexed with the predetermined portion of the input signal.

Similarly, there is a set to be multiplexed at a third column as shown in FIG. 1 (referred to as a third multiplex set). The third multiplex set contains DID (referred to as “D3” in FIG. 1) stored on the register 1-11, SDID (hereinafter referred to as “S3” in FIG. 1) stored on the register 1-15, and the metadata (referred to as “M3”) on the register 1-19. If a predetermined portion of the input signal satisfies the third set of multiplexing conditions, the third set of multiplexing conditions is multiplexed with the predetermined portion of the input signal.

Similarly, there is a set to be multiplexed at a fourth column as shown in FIG. 1 (referred to as a fourth multiplex set). The fourth multiplex set contains DID (referred to as “D4” in FIG. 1) stored on the register 1-12, SDID (hereinafter referred to as “S4” in FIG. 1) stored on the register 1-16, and the metadata (referred to as “M4”) on the register 1-20. If a predetermined portion of the input signal satisfies the fourth set of multiplexing conditions, the fourth set of multiplexing conditions is multiplexed with the predetermined portion of the input signal.

Each comparator 2-k (k is an integer falling within a range of 1 through 4) is supplied with signal information representing H_ANC/V_ANC period in synchronization with the input signal (hereinafter referred to as input H/V information), and signal information representing Line_Number (hereinafter referred to as input Line No.) (with no supply sources shown). Each comparator 2-K reads the k-th multiplexing condition set from the corresponding two registers 1 (two registers 1 in the upper portion of FIG. 1). Specifically, each comparator 2-k reads the H_ANC/V_ANC period (Hk) and the Line_Number (Lk) from the respective two registers 1. Each 2-k comparator compares the input H/V information with the H_ANC/V_ANC period (Hk), compares the input Line No. with Line_Number (Lk) and outputs comparison results to a multiplex timing controller 3.

Based on the comparison results of each comparator 2-k, and the input H/V information and the input Line No., the multiplex timing controller 3 generates a signal specifying which of the first through fourth multiplex sets is to be multiplexed (hereinafter referred to as a selection signal) and a signal indicating a timing at which the multiplex set is multiplexed with the input signal (hereinafter referred to as a timing signal). The multiplex timing controller 3 supplies the selection signal to a metadata selector and reader 4 and the timing signal to a multiplexer 5.

The metadata selector and reader 4 reads one of the first through fourth multiplex sets, specified by the multiplex timing controller 3, from the corresponding three registers 1 in the upper portion of FIG. 1, and supplies the read multiplex set to the multiplexer 5. For example, if the selection signal from the multiplex timing controller 3 specifies an m-th multiplex set (m is an integer within a range of 1 through 4), the DID (Dm), the SDID (Sm), and the metadata (Mm) are respectively read from the three m-th registers 1 from the left side and then supplied to the multiplexer 5.

In response to the timing signal from the multiplex timing controller 3, the multiplexer 5 multiplexes the DID (Dm), the SDID (Sm), and the metadata (Mm) at the m-th multiplex set supplied from the metadata selector and reader 4 with the corresponding portions of the input signal (the portions identified by the input H/V information and the input Line No. input to each comparator 2-k), and transmits the resulting signal as a transmission signal.

A metadata multiplexer in the known transmitter of FIG. 1 operates as below.

The comparator 2-k determines which of the first through fourth multiplex sets matches the set of the input H/V information and the input Line No. or determines whether none of the first through fourth multiplex sets matches the set of the input H/V information and the input Line No.

If it is determined that none of the first through fourth multiplex sets matches the set of the input H/V information and the input Line No., no metadata is multiplexed with that portion identified by the set of the input H/V information and the input Line No. That portion of the input signal is directly output (transmitted) as is.

If it is determined that the set of the input H/V information and the input Line No. matches the m-th multiplex set, the multiplex timing controller 3 supplies the metadata selector and reader 4 with the selection signal specifying the selection of the m-th multiplex set, and supplies the multiplexer 5 with the timing signal indicating the timing at which the m-th multiplex set is to be multiplexed with the input signal.

In response to the selection signal, the metadata selector and reader 4 reads the m-th multiplex set from the registers 1 and supplies the read m-th multiplex set to the multiplexer 5. In response to the timing signal, the multiplexer 5 multiplexes the m-th multiplex set with the corresponding portion (the portion identified by the set of the input H/V information and the input Line No.) of the input signal, and transmits the resulting signal as a portion of a transmission signal.

The transmission signal (not shown) is parallel-to-serial converted into a serial signal, and then received by a known receiver that receives a HD_SDI signal.

A portion of the known HD_SDI signal receiving receiver for extracting the metadata (hereinafter referred to as meta extractor) is shown in FIG. 2.

The meta extractor of the known receiver of FIG. 2 includes a register 11 through a metadata selector and writer 15.

The meta extractor of FIG. 2 receives the transmission signal from the known transmitter including the meta multiplexer of FIG. 1. In the meta extractor, the transmission signal, namely, the HD_SDI signal with the first through fourth multiplex sets multiplexed with the corresponding portions of the input signal (serial signal) is serial-to-parallel converted. The resulting parallel signal is input to the meta extractor as a reception signal.

The HD_SDI signal contains a plurality of conditions including a condition for extracting the metadata (hereinafter referred to as extraction condition), a condition relating to whether it is in H_Blanking period (H_ANC), a condition relating to whether it is in V_Blanking period (V_ANC), a condition relating to at what line the metadata is inserted, and a condition relating to corresponding DID and SDID. Data of the extraction conditions (hereinafter referred to as extraction condition data) is conventionally stored on registers such as a register 11 of FIG. 2.

The register 11 store the variety of extraction condition data. More specifically, H_ANC/V_ANC periods as one type of extraction condition data are stored on the registers 11-1 through 11-4 on a condition-by-condition basis, Line_Numbers as another type of extraction condition data are stored on the registers 11-5 through 11-8 on a condition-by-condition basis, DIDs (Data IDs) as yet another type of extraction condition data are stored on the registers 11-9 through 11-12 on a condition-by-condition basis, and SDIDs (secondary Data IDs) as still another extraction condition data are stored on the registers 11-13 through 11-16 on a condition-by-condition basis.

The meta extractor of FIG. 2 corresponds to the meta multiplexer of FIG. 1. In a way similar to the one shown in FIG. 1, four pieces of extraction condition data stored in registers vertically arranged in a column as shown in FIG. 2 are combined in a set (hereinafter referred to as extraction condition set). If it is determined that all types of the H_ANC/V_ANC period, the Line_Number, the DID, and the SDID belonging to the set match those of the input, the extraction conditions are satisfied.

More specifically, as shown in FIG. 2, an extraction condition set at a first column (hereinafter referred to as first extraction condition set) is stored on the registers 11-1, 11-5, 11-9, and 11-13. More specifically, the register 11-1 stores the H_ANC/V_ANC period (the same as the condition data stored on the register 1-1 of FIG. 1 as is known from a label “H1” in FIG. 2), the register 11-5 stores the Line_Number (the same as the condition data stored on the register 1-5 of FIG. 1 as is known from a label “L1” of FIG. 2), the register 11-9 stores the DID (the same as the condition data stored on the register 1-9 of FIG. 1 as is known from a label “D1” of FIG. 2), and the register 11-13 stores the SDID (the same as the condition data stored on the register 1-13 of FIG. 1 as is known from a label “S1” of FIG. 2).

Similarly, as shown in FIG. 2, an extraction condition set at a second column (hereinafter referred to as second extraction condition set) is stored on the registers 11-2, 11-6, 11-10, and 11-14. More specifically, the register 11-2 stores the H_ANC/V_ANC period (the same as the condition data stored on the register 1-2 of FIG. 1 as is known from a label “H2” in FIG. 2), the register 11-6 stores the Line_Number (the same as the condition data stored on the register 1-6 of FIG. 1 as is known from a label “L2” of FIG. 2), the register 11-10 stores the DID (the same as the condition data stored on the register 1-10 of FIG. 1 as is known from a label “D2” of FIG. 2), and the register 11-14 stores the SDID (the same as the condition data stored on the register 1-14 of FIG. 1 as is known from a label “S2” of FIG. 2).

Similarly, as shown in FIG. 2, an extraction condition set at a third column (hereinafter referred to as third extraction condition set) is stored on the registers 11-3, 11-7, 11-11, and 11-15. More specifically, the register 11-3 stores the H_ANC/V_ANC period (the same as the condition data stored on the register 1-3 of FIG. 1 as is known from a label “H3” in FIG. 2), the register 11-7 stores the Line_Number (the same as the condition data stored on the register 1-7 of FIG. 1 as is known from a label “L3” of FIG. 2), the register 11-11 stores the DID (the same as the condition data stored on the register 1-11 of FIG. 1 as is known from a label “D3” of FIG. 2), and the register 11-15 stores the SDID (the same as the condition data stored on the register 1-15 of FIG. 1 as is known from a label “S3” of FIG. 2).

Similarly, as shown in FIG. 2, an extraction condition set at a fourth column (hereinafter referred to as fourth extraction condition set) is stored on the registers 11-4, 11-8, 11-12, and 11-16. More specifically, the register 11 -4 stores the H_ANC/V_ANC period (the same as the condition data stored on the register 1-4 of FIG. 1 as is known from a label “H4” in FIG. 2), the register 11-8 stores the Line_Number (the same as the condition data stored on the register 1-8 of FIG. 1 as is known from a label “L4” of FIG. 2), the register 11-12 stores the DID (the same as the condition data stored on the register 1-12 of FIG. 1 as is known from a label “D4” of FIG. 2), and the register 11-16 stores the SDID (the same as the condition data stored on the register 1-16 of FIG. 1 as is known from a label “S4” of FIG. 2).

The registers 11 also store a variety of metadata extracted from the reception signal (four types of data in FIG. 2). More specifically, the register 11-17 of FIG. 2 stores the metadata multiplexed on the portion of the reception signal satisfying the first extraction condition, namely, the metadata (M1) stored on the register 1-17 of FIG. 1. The register 11-18 of FIG. 2 stores the metadata multiplexed on the portion of the reception signal satisfying the second extraction condition, namely, the metadata (M2) stored on the register 1-18 of FIG. 1. The register 11-19 of FIG. 2 stores the metadata multiplexed on the portion of the reception signal satisfying the third extraction condition, namely, the metadata (M3) stored on the register 1-19 of FIG. 1. The register 11-20 of FIG. 2 stores the metadata multiplexed on the portion of the reception signal satisfying the fourth extraction condition, namely, the metadata (M4) stored on the register 1-20 of FIG. 1.

Each comparator 12-o (o is an integer falling with a range from 1 through 4) receives signal information indicating the DID and SDID synchronized with the reception signal (hereinafter referred to as input DID/SDID), input H/V information, and input Line No. (with no supply source identified). Each comparator 12-o reads an o-th extraction condition set from four corresponding registers 11 shown in the upper portion of FIG. 2. More specifically, each comparator 12-o reads the H_ANC/V_ANC period (Ho), the Line_Number (Lo), the DID (Do), and the SDID (So) from the respective four registers 11. Each comparator 12-o compares the DID (Do) and the SDID (So) with the input DID/SDID, the H_ANC/V_ANC period (Ho) with the input H/V information, and the Line_Number (Lo) with the input Line No., and outputs the comparison results to an extraction timing controller 13.

Based on the comparison results from each comparator 12-o, the input H/V information, and the Line No., the extraction timing controller 13 generates a signal specifying the metadata identified by each the first through fourth extraction condition sets (hereinafter referred to as a selection signal) and a signal indicating a timing at which the metadata is extracted (hereinafter referred to as a timing signal). The extraction timing controller 13 supplies the selection signal to a metadata selector and writer 15 and the timing signal to an extractor 14.

The extractor 14 extracts the metadata in response to the timing signal from the extraction timing controller 13 and supplies the extracted metadata to the metadata selector and writer 15.

The metadata selector and writer 15 stores the metadata from the extractor 14 onto a register, from among the registers 11-17 through 11-20, identified by the selection signal from the extraction timing controller 13 (for example, the register 11-17 for storing the metadata (M1)).

The operation of the meta extractor of the known receiver of FIG. 2 is described below.

Each comparator 2-o determines which of the first through fourth extraction condition sets matches the set of the input DID/SDID, the input H/V information and the input Line No. or determines whether none of the first through fourth extraction condition sets matches the set of the DID/SDID, the input H/V information and the input Line No.

If it is determined that none of the first through fourth extraction condition sets matches the set of the input DID/SDID, the input H/V information and the input Line No., no metadata has not been multiplexed with that portion identified by the set of the DID/SDID, the input H/V information and the input Line No. The extraction process of the metadata is thus inhibited.

If it is determined that the set of the input DID/SDID, the input H/V information and the input Line No. matches the p-th extraction condition set (p is an integer falling with a range from 1 to 4), the extraction timing controller 13 supplies the metadata selector and writer 15 with the selection signal specifying the selection of the metadata (Mp) identified by the p-th extraction condition set. The extraction timing controller 13 also supplies the extractor 14 with the timing signal indicating the timing at which the metadata (Mp) is to be extracted.

In response to the timing signal, the extractor 14 extracts the metadata (Mp) from the reception signal, and supplies the metadata selector and writer 15 with the metadata (Mp). The metadata selector and writer 15 stores the metadata (Mp) onto the register from among the registers 11-17 through 11-20 identified by the selection signal from the extraction timing controller 13.

As described above, the multiplexing condition data of the transmitter for transmitting the HD_SDI signal and the extraction condition data of the receiver for receiving the HD_SDI signal are conventionally stored on the registers.

### SUMMARY OF THE INVENTION

A major reason why multiplex condition data and extraction condition data are stored on registers is that the number of types (units) of metadata to be multiplexed with HD_SDI data is not so large. In each of FIGS. 1 and 2, the number of types of metadata is four.

However, the number of types (units) of metadata is currently increasing. Occasionally, 16 types of metadata are used. More specifically, the metadata may include a variety of types of data such as time code, vertical time code (VITC), caption information, video format information, commercial information, and audio information. As the number of types of metadata increases, the number of registers also increases.

An increase in the number of registers leads to the following problem. If each of the meta multiplexer in the transmitter and the meta extractor in the receiver is constructed of internal logic elements (basic elements of a register) such as FPGAs, the usage rate of each logic element becomes high. For this reason, the number of logic elements must be increased, and efficient layout cannot be achieved. Finally, the number of registers is also increased.

It is thus desirable to reduce the usage rate of a logic portion of a multiplexer for multiplexing metadata and an extractor for extracting the metadata and to achieve an efficient layout.

In accordance with one embodiment of the present invention, a transmission and reception system includes a transmitter configured to transmit stream data into which first metadata and second metadata are multiplexed, and a receiver configured to receive the stream data transmitted by the transmitter and extracting the first metadata and the second metadata from the stream data. The transmitter includes a multiplexing condition storage unit configured to store a first multiplexing condition for multiplexing the first metadata into the stream data, and a second multiplexing condition for multiplexing the second metadata into the stream data, a multiplex determination unit configured to successively read from the multiplexing condition storage unit the first multiplexing condition and the second multiplexing condition in a predetermined order sequence, and configured to successively determine in the predetermined order sequence whether a predetermined portion of the stream data satisfies one of the first multiplexing condition and the second multiplexing condition, a multiplexing unit configured to multiplex the first metadata to the portion of the stream data that the multiplex determination unit has determined as satisfying the first multiplexing condition, and configured to multiplex the second metadata to the portion of the stream data that the multiplex determination unit has determined as satisfying the second multiplexing condition, and a transmitting unit configured to transmit the stream data into which the multiplexing unit has multiplexed the first metadata and the second metadata. The receiver includes a receiving unit configured to receive the stream data transmitted from the transmitter, an extraction condition storage unit configured to store a first extraction condition for extracting the first metadata from the stream data and a second extraction condition for extracting the second metadata from the stream data, an extraction determination unit configured to successively read the first extraction condition and the second extraction condition in a predetermined order sequence from the extraction condition storage unit and configured to successively determine in the predetermined order sequence whether a predetermined portion of the stream data received by the receiving unit satisfies one of the first extraction condition and the second extraction condition, and an extracting unit configured to extract the first metadata from the portion of the stream data received by the receiving unit and determined by the extraction determination unit as satisfying the first extraction condition and configured to extract the second metadata from the portion of the stream data received by the receiving unit and determined by the extraction determination unit as satisfying the second extraction condition.

Another embodiment of the present invention relates to a transmission and reception method of a transmission and reception system including a transmitter for transmitting stream data into which first metadata and second metadata are multiplexed, the transmitter including at least a multiplexing condition memory storing a first multiplexing condition for multiplexing the first metadata into the stream data, and a second multiplexing condition for multiplexing the second metadata into the stream data, and a receiver for receiving the stream data transmitted from the transmitter, and extracting the first metadata and the second metadata from the stream data, the receiver including at least an extraction condition memory for storing a first extraction condition for extracting the first metadata from the stream data and a second extraction condition for extracting the second metadata from the stream data. The method includes the steps of successively reading from the multiplexing condition memory the first multiplexing condition and the second multiplexing condition in a predetermined order sequence, and successively determining in the predetermined order sequence whether a predetermined portion of the stream data satisfies one of the first multiplexing condition and the second multiplexing condition, multiplexing the first metadata to the portion of the stream data that is determined as satisfying the first multiplexing condition, and multiplexing the second metadata to the portion of the stream that is determined as satisfying the second multiplexing condition, transmitting the stream data into which the first metadata and the second metadata have been multiplexed, receiving the stream data transmitted from the transmitter, successively reading the first extraction condition and the second extraction condition in a predetermined order sequence from the extraction condition memory and successively determining in the predetermined order sequence whether a predetermined portion of the received stream data satisfies one of the first extraction condition and the second extraction condition, and extracting the first metadata from the portion of the received stream data that is determined as satisfying the first extraction condition and extracting the second metadata from the portion of the received data stream that is determined as satisfying the second extraction condition.

In accordance with embodiments of the present invention, the transmission and reception system includes the transmitter for transmitting the stream data into which the first metadata and the second metadata are multiplexed, the transmitter including at least the multiplexing condition memory storing the first multiplexing condition for multiplexing the first metadata into the stream data, and the second multiplexing condition for multiplexing the second metadata into the stream data, and the receiver for receiving the stream data transmitted from the transmitter, and extracting the first metadata and the second metadata from the stream data, the receiver including at least the extraction condition memory for storing the first extraction condition for extracting the first metadata from the stream data and the second extraction condition for extracting the second metadata from the stream data. The transmitter successively reads from the multiplexing condition memory the first multiplexing condition and the second multiplexing condition in the predetermined order sequence, successively determines in the predetermined order sequence whether the predetermined portion of the stream data satisfies one of the first multiplexing condition and the second multiplexing condition, multiplexes the first metadata to the portion of the stream data that is determined as satisfying the first multiplexing condition, multiplexes the second metadata to the portion of the stream that is determined as satisfying the second multiplexing condition, and transmits the stream data into which the first metadata and the second metadata have been multiplexed. The receiver receives the stream data transmitted from the transmitter, successively reads the first extraction condition and the second extraction condition in the predetermined order sequence from the extraction condition memory, successively determines in the predetermined order sequence whether the predetermined portion of the received stream data satisfies one of the first extraction condition and the second extraction condition, extracts the first metadata from the portion of the received stream data that is determined as satisfying the first extraction condition and extracts the second metadata from the portion of the received data stream that is determined as satisfying the second extraction condition.

In accordance with yet another embodiment of the present invention, a transmitter for transmitting stream data into which first metadata and second metadata are multiplexed, includes a multiplexing condition storage unit configured to store a first multiplexing condition for multiplexing the first metadata into the stream data, and a second multiplexing condition for multiplexing the second metadata into the stream data, a multiplex determination unit configured to successively read from the multiplexing condition storage unit the first multiplexing condition and the second multiplexing condition in a predetermined order sequence, and configured to successively determine in the predetermined order sequence whether a predetermined portion of the stream data satisfies one of the first multiplexing condition and the second multiplexing condition, a multiplexing unit configured to multiplex the first metadata to the portion of the stream data that the multiplex determination unit has determined as satisfying the first multiplexing condition, and configured to multiplex the second metadata to the portion of the stream data that the multiplex determination unit has determined as satisfying the second multiplexing condition, and a transmitting unit configured to transmit the stream data into which the multiplexing unit has multiplexed the first metadata and the second metadata.

The first multiplexing condition may contain information that identifies a portion of the stream data where the first metadata is predetermined to be multiplexed. The second multiplexing condition may contain information that identifies a portion of the stream data where the second metadata is predetermined to be multiplexed. The multiplex determination unit may determine the predetermined portion of the stream data as satisfying the first multiplexing condition if the predetermined portion of the stream data is the portion identified by the first multiplexing condition and determine the predetermined portion of the stream data as satisfying the second multiplexing condition if the predetermined portion of the stream data is the portion identified by the second multiplexing condition.

Each of the first multiplexing condition and the second multiplexing condition may include a first type and a second type. The multiplexing condition storage unit may include a first memory for storing the first and second multiplexing conditions of the first type, and a second memory for storing the first and second multiplexing conditions of the second type. The multiplex determination unit may successively read from the multiplexing condition storage unit in the predetermined order sequence the first multiplexing conditions of the first type and the second type and the second multiplexing conditions of the first type and the second type, and successively determine in the predetermined order sequence whether the predetermined portion of the stream data satisfies the first multiplexing conditions of the first type and the second type or the second multiplexing conditions of the first type and the second type. The multiplexing unit may multiplex the first metadata with the portion of the stream data if the multiplex determination unit determines that the portion of the stream data satisfies the first multiplexing conditions of the first type and the second type, and multiplex the second metadata with the portion of the stream data if the multiplex determination unit determines that the portion of the stream data satisfies the second multiplexing conditions of the first type and the second type.

The transmitter may further include an address control unit. The address control unit sets an area of the first memory storing the first multiplexing condition of the first type to a first address, and an area of the first memory storing the second multiplexing condition of the first type to a second address, sets an area of the second memory storing the first multiplexing condition of the second type to the first address and an area of the second memory storing the second multiplexing condition of the second type to the second address, and notifies the multiplex determination unit of the setting content. The multiplex determination unit reads from the multiplexing condition storage unit the first multiplexing conditions of the first type and the second type or the second multiplexing conditions of the first type and the second type in accordance with the setting content of which the address control unit has notified the multiplex determination unit.

The transmitter may further include a memory unit configured to store the first metadata and the second metadata, and a metadata reading unit configured to read the first metadata from the memory unit if the multiplex determination unit has determined that the first multiplexing condition is satisfied, and configured to read the second metadata from the memory unit if the multiplex determination unit has determined that the second multiplexing condition is satisfied. The multiplexing unit multiplexes the first metadata read by the metadata reading unit with the portion of the stream data that the multiplex determination unit has determined as satisfying the first multiplexing condition, and multiplexes the second metadata read by the metadata reading unit with the portion of the stream data that the multiplex determination unit has determined as satisfying the second multiplexing condition.

The data size of a portion of the stream data with which the metadata is multiplexed is defined, and one of the first metadata and the second metadata exceeds the defined data size, and is divided on a per defined data size basis into N data units (N is an integer equal to or larger than 2). One of the first multiplexing condition and the second multiplexing condition includes N units of multiplexing conditions for multiplexing the N data units with the steam data. One of the first multiplexing condition and the second multiplexing condition includes N units of multiplexing condition and when one of the first multiplexing condition and the second multiplexing condition is to be read, the multiplex determination unit successively reads each of the N units of multiplexing conditions in a predetermined order sequence from the multiplexing condition storage unit, and determines in the order sequence whether a predetermined portion of the stream data satisfies the read unit of multiplexing condition. The multiplexing unit multiplexes each of the N data units divided from one of the first metadata and the second metadata with each of N units of the stream data that the multiplex determination unit has determined as satisfying each of the N units of multiplexing conditions.

In accordance with embodiments of the present invention, a transmitting method/program of a transmitter/apparatus for transmitting stream data into which first metadata and second metadata are multiplexed, the transmitter/apparatus including at least a memory for storing a first multiplexing condition for multiplexing the first metadata into the stream data, and a second multiplexing condition for multiplexing the second metadata into the stream data, includes the steps of, prior to transmitting the stream data into which the first metadata and the second metadata are multiplexed, successively reading the first multiplexing condition and the second multiplexing condition from the memory in a predetermined order sequence, determining in the predetermined order sequence whether a predetermined portion of the stream data satisfies one of the first multiplexing condition and the second multiplexing condition, multiplexing the first metadata with the portion of the stream data that is determined as satisfying the first multiplexing condition, and multiplexing the second metadata with the portion of the stream that is determined as satisfying the second multiplexing condition.

In accordance with embodiments of the present invention, the transmitting method/program is related to the transmitter/apparatus for transmitting stream data into which first metadata and second metadata are multiplexed, the transmitter/apparatus including at least the memory for storing the first multiplexing condition for multiplexing the first metadata into the stream data, and the second multiplexing condition for multiplexing the second metadata into the stream data. The transmitter/apparatus successively reads the first multiplexing condition and the second multiplexing condition from the memory in a predetermined order sequence, determines in the predetermined order sequence whether the predetermined portion of the stream data satisfies one of the first multiplexing condition and the second multiplexing condition, multiplexes the first metadata to the portion of the stream data that is determined as satisfying the first multiplexing condition, and multiplexes the second metadata to the portion of the stream that is determined as satisfying the second multiplexing condition.

In accordance with another embodiment of the present invention, a receiver for receiving stream data into which first metadata and second metadata are multiplexed, and extracting the first metadata and the second metadata from the stream data, includes a receiving unit configured to receive the stream data, an extraction condition storage unit configured to store a first extraction condition for extracting the first metadata from the stream data and a second extraction condition for extracting the second metadata from the stream data, an extraction determination unit configured to successively reading the first extraction condition and the second extraction condition in a predetermined order sequence from the extraction condition storage unit and configured to determine successively in the predetermined order sequence whether a predetermined portion of the stream data received by the receiving unit satisfies one of the first extraction condition and the second extraction condition, and an extracting unit configured to extract the first metadata from the portion of the stream data received by the receiving unit and determined by the extraction determination unit as satisfying the first extraction condition and configured to extract the second metadata from the portion of the stream data received by the receiving unit and determined by the extraction determination unit as satisfying the second extraction condition.

The first extraction condition contains information that identifies a portion of the stream data where the first metadata is predetermined to be multiplexed. The second extraction condition contains information that identifies a portion of the stream data where the second metadata is predetermined to be multiplexed. The extraction determination unit determines a predetermined portion of the stream data received by the receiving unit as satisfying the first extraction condition if the predetermined portion of the stream data is the portion identified by the first extraction condition and determines the predetermined portion of the stream data as satisfying the second extraction condition if the predetermined portion of the stream data is the portion identified by the second extraction condition.

Each of the first extraction condition and the second extraction condition includes a first type and a second type. The extraction condition storage unit includes a first memory for storing the first and second extraction conditions of the first type, and a second memory for storing the first and second extraction conditions of the second type. The extraction determination unit successively reads from the extraction condition storage unit in the predetermined order sequence the first extraction conditions of the first type and the second type and the second extraction conditions of the first type and the second type, and successively determines in the predetermined order sequence whether the predetermined portion of the stream data satisfies the first extraction conditions of the first type and the second type or the second extraction conditions of the first type and the second type. The extracting unit extracts the first metadata from the portion of the stream data that the extraction determination unit determines as satisfying the first extraction conditions of the first type and the second type, and extracts the second metadata from the portion of the stream data that the extraction determination unit determines as satisfying the second extraction conditions of the first type and the second type.

The receiver may further include an address control unit. The address control unit sets an area of the first memory storing the first extraction condition of the first type to a first address, and an area of the first memory storing the second extraction condition of the first type to a second address, sets an area of the second memory storing the first extraction condition of the second type to the first address and an area of the second memory storing the second extraction condition of the second type to the second address, and notifies the extraction determination unit of the setting content. The extraction determination unit reads from the extraction condition storage unit the first extraction conditions of the first type and the second type or the second extraction conditions of the first type and the second type in accordance with the setting content of which the address control unit has notified the extraction determination unit.

The receiver may further include a memory unit configured to store the first metadata and the second metadata, and a metadata writing unit configured to write one of the first metadata and the second metadata extracted by the extracting unit onto the memory unit.

In the receiver, the data size of a portion of the stream data with which the metadata is multiplexed is defined, and one of the first metadata and the second metadata exceeds the defined data size, and is divided on a per defined data size basis into N data units (N is an integer equal to or larger than 2), and the N data units have been multiplexed with different portions of the stream data. One of the first extraction condition and the second extraction conditions includes N units of extraction condition for extracting the N data units from the steam data. One of the first extraction condition and the second extraction condition includes N units of extraction conditions and when one of the first extraction condition and the second extraction condition is to be read, the extraction determination unit successively reads each of the N units of extraction conditions in a predetermined order sequence from the extraction condition storage unit, and determines in the order sequence whether a predetermined portion of the stream data satisfies the read unit of extraction condition. The extraction unit extracts each of the N data units divided from one of the first metadata and the second metadata from each of N units of the stream data that the extraction determination unit has determined as satisfying each of the N units of extraction conditions.

In accordance with embodiments of the present invention, a receiving method/program of a receiver/apparatus for receiving stream data into which first metadata and second metadata are multiplexed, and extracting the first metadata and the second metadata from the stream data, the receiver/apparatus including at least a memory for storing a first extraction condition for extracting the first metadata from the stream data, and a second extraction condition for extracting the second metadata from the stream data, includes the steps of successively reading the first extraction condition and the second extraction condition from the memory in a predetermined order sequence, and determining in the predetermined order sequence whether a predetermined portion of the stream data received by the receiver satisfies one of the first extraction condition and the second extraction condition, and extracting the first metadata from the portion of the stream data received by the receiver and determined as satisfying the first extraction condition, and extracting the second metadata from the portion of the stream data received by the receiver and determined as satisfying the second extraction condition.

In accordance with embodiments of the present invention, the receiving method/program relates to the receiver/apparatus for receiving the stream data in which the first metadata and the second metadata are multiplexed, and extracting the first metadata and the second metadata from the stream data. The receiver/apparatus includes at least the memory for storing the first extraction condition for extracting the first metadata from the stream data, and the second extraction condition for extracting the second metadata from the stream data. The receiver/apparatus successively reads the first extraction condition and the second extraction condition from the memory in a predetermined order sequence, determines in the predetermined order sequence whether a predetermined portion of the stream data received by the apparatus satisfies one of the first extraction condition and the second extraction condition, extracts the first metadata from the portion of the stream data received by the apparatus and determined as satisfying the first extraction condition, and extracts the second metadata from the portion of the stream data received by the apparatus and determined as satisfying the second extraction condition.

Each of the first metadata and the second metadata is simply any data that can be multiplexed onto stream data.

A transfer method of the stream data from the transmitter to the receiver is not limited to any particular method. The data transfer may be performed in a wired fashion, or in a wireless fashion, or a combination of both. The data transfer may be performed via one or more networks.

In accordance with embodiments of the present invention, the usage rate of a logic portion of the multiplexer for multiplexing metadata and the extractor for extracting the metadata is reduced and an efficient layout is implemented.

### BRIEF DESCRIPTION OF THE DRAWINGS

FIG. 1 is a block diagram of a known transmitter;

FIG. 2 is a block diagram of a known receiver;

FIG. 3 illustrates a transmission and reception system of one embodiment of the present invention;

FIG. 4 illustrates in detail a meta multiplexer of the transmitter in the transmission and reception system of FIG. 3;

FIG. 5 is a flowchart illustrating a metadata multiplex process mainly performed by the meta multiplexer in the transmitter of FIG. 4;

FIG. 6 illustrates in detail a meta extractor in a receiver in the transmission and reception system of FIG. 3;

FIG. 7 is a flowchart illustrating a metadata extraction process mainly performed by the meta extractor in the receiver of the transmission and reception system of FIG. 3; and

FIG. 8 is a block diagram illustrating a personal computer executing a program of one embodiment of the present invention.

### DESCRIPTION OF THE PREFERRED EMBODIMENTS

Before describing an embodiment of the present invention, the correspondence between the features of the claims and the specific elements disclosed in an embodiment of the present invention is discussed below. This description is intended to assure that embodiments supporting the claimed invention are described in this specification. Thus, even if an element in the following embodiments is not described as relating to a certain feature of the present invention, that does not necessarily mean that the element does not relate to that feature of the claims. Conversely, even if an element is described herein as relating to a certain feature of the claims, that does not necessarily mean that the element does not relate to other features of the claims.

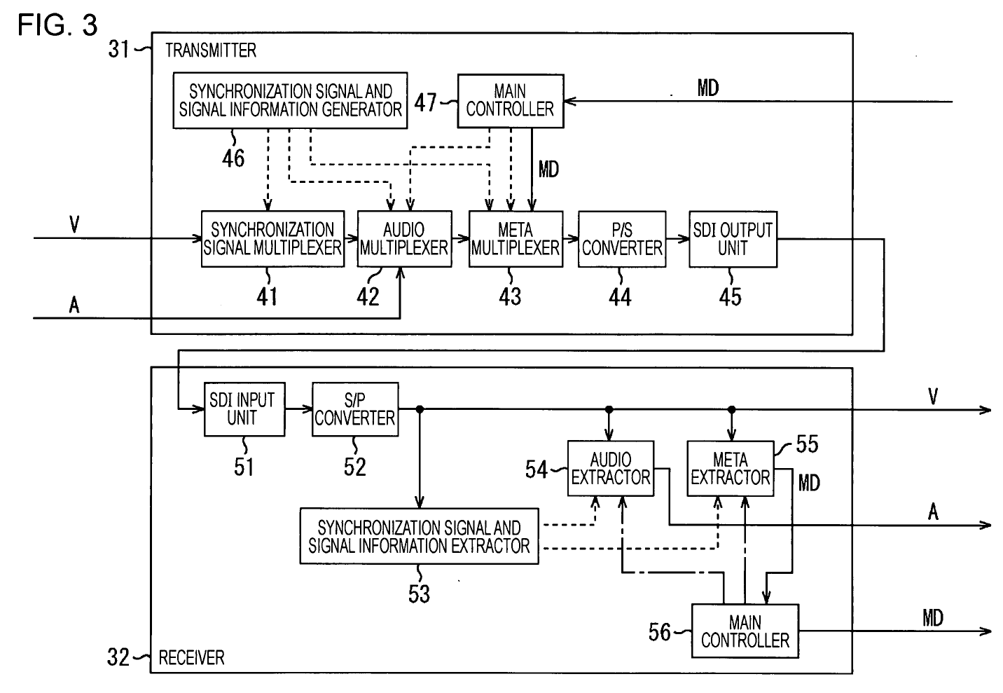

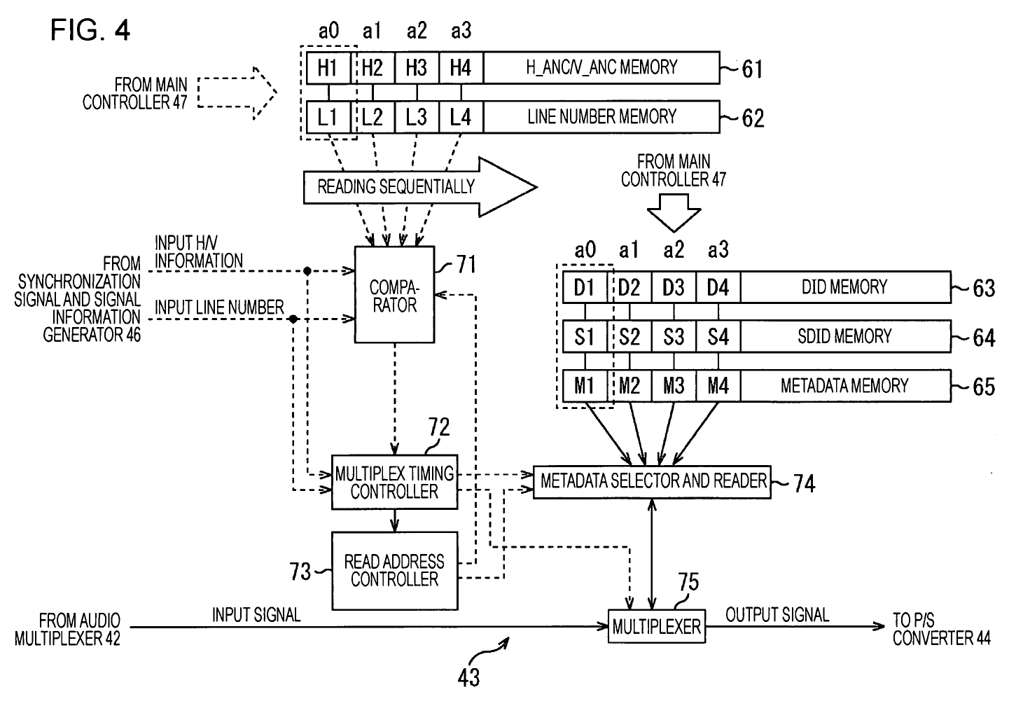

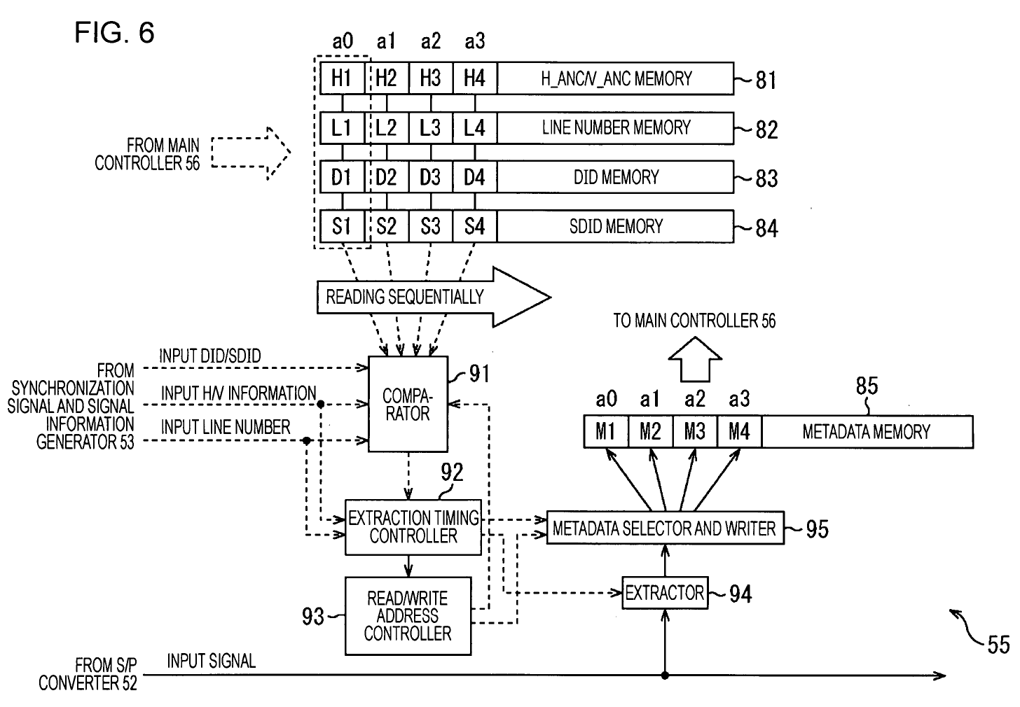

In accordance with one embodiment of the present invention, a transmission and reception system (for example, system of FIG. 3) includes a transmitter (for example, transmitter 31 of FIG. 3) for transmitting stream data (for example, input signal of FIG. 4 which is obtained by multiplexing audio data A with video data V of FIG. 3) into which first metadata (for example, a set of one unit of metadata (M1 through M4) stored on metadata memory 65 and corresponding units of other metadata (S1 through S4) and (D1 through D4)) and second metadata (for example, a set of another unit of metadata (M1 through M4) stored on metadata memory 65 and corresponding units of other metadata (S1 through S4) and (D1 through D4)) are multiplexed, and a receiver (for example, receiver 32 of FIG. 3) for receiving the stream data transmitted by the transmitter and extracting the first metadata and the second metadata from the stream data. The transmitter includes a multiplexing condition storage unit (for example, one of H_ANC/V_ANC memory 61 and line number memory 62 of FIG. 4 in meta multiplexer 43 of FIG. 3) configured to store a first multiplexing condition (for example, one of multiplexing conditions (H1 through H4) stored on H_ANC/V_ANC memory 61 of FIG. 4 or one of multiplexing conditions (L1 through L4) stored on line number memory 62 of FIG. 4) for multiplexing the first metadata into the stream data, and a second multiplexing condition (for example, another one of multiplexing conditions (H1 through H4) stored on H_ANC/V_ANC memory 61 of FIG. 4 or another one of multiplexing conditions (L1 through L4) stored on line number memory 62 of FIG. 4) for multiplexing the second metadata into the stream data, a multiplex determination unit (for example, comparator 71 in FIG. 4 in meta multiplexer 43 of FIG. 3) configured to successively read from the multiplexing condition storage unit the first multiplexing condition and the second multiplexing condition in a predetermined order sequence, and configured to successively determine in the predetermined order sequence whether a predetermined portion of the stream data satisfies one of the first multiplexing condition and the second multiplexing condition, a multiplexing unit (for example, multiplexer 75 in FIG. 4 in meta multiplexer 43 of FIG. 3) configured to multiplex the first metadata to the portion of the stream data that the multiplex determination unit has determined as satisfying the first multiplexing condition, and configured to multiplex the second metadata to the portion of the stream data that the multiplex determination unit has determined as satisfying the second multiplexing condition, and a transmitting unit (for example, SDI output unit 45 of FIG. 3) configured to transmit the stream data into which the multiplexing unit has multiplexed the first metadata and the second metadata. The receiver includes a receiving unit (for example, SDI input unit 51 of FIG. 3) configured to receive the stream data transmitted from the transmitter, an extraction condition storage unit (for example, H_ANC/V_ANC memory 81, line number memory 82, DID memory 83, SDID memory 84, etc. of FIG. 6 in meta extractor 55 of FIG. 3) configured to store a first extraction condition (for example, one of extraction conditions (H1 through H4) stored on H_ANC/V_ANC memory 81 of FIG. 6, one of extraction conditions (L1 through L4) stored on line number memory 82, one of extraction conditions (D1 through D4) stored on DID memory 83, and one of extraction conditions (S1 through S4) stored on SDID memory 84) for extracting the first metadata from the stream data and a second extraction condition (for example, another one of extraction conditions (H1 through H4) stored on H_ANC/V_ANC memory 81 of FIG. 6, another one of extraction conditions (L1 through L4) stored on line number memory 82, another one of extraction conditions (D1 through D4) stored on DID memory 83, and another one of extraction conditions (S1 through S4) stored on SDID memory 84) for extracting the second metadata from the stream data, an extraction determination unit (for example, comparator 91 of FIG. 6 in meta extractor 55 of FIG. 3) configured to successively read the first extraction condition and the second extraction condition in a predetermined order sequence from the extraction condition storage unit and configured to successively determine in the predetermined order sequence whether a predetermined portion of the stream data received by the receiving unit satisfies one of the first extraction condition and the second extraction condition, and an extracting unit (for example, extractor 94 of FIG. 6 in meta extractor 55 of FIG. 3) configured to extract the first metadata from the portion of the stream data received by the receiving unit and determined by the extraction determination unit as satisfying the first extraction condition and configured to extract the second metadata from the portion of the stream data received by the receiving unit and determined by the extraction determination unit as satisfying the second extraction condition.

In accordance with one embodiment of the present invention, a transmission and reception method has the same function of the above-described transmission and reception system.

In accordance with another embodiment of the present invention, a transmitter (for example, transmitter 31 of FIG. 3) for transmitting stream data (for example, input signal of FIG. 4 which is obtained by multiplexing audio data A with video data V of FIG. 3) into which first metadata (for example, a set of one unit of metadata (M1 through M4) stored on metadata memory 65 and corresponding units of other metadata (S1 through S4) and (D1 through D4)) and second metadata (for example, a set of another unit of metadata (M1 through M4) stored on metadata memory 65 and corresponding units of other metadata (S1 through S4) and (D1 through D4)) are multiplexed, includes a multiplexing condition storage unit (for example, one of H_ANC/V_ANC memory 61 and line number memory 62 of FIG. 4 in meta multiplexer 43 of FIG. 3) configured to store a first multiplexing condition (for example, one of multiplexing conditions (H1 through H4) stored on H_ANC/V_ANC memory 61 of FIG. 4 or one of multiplexing conditions (L1 through L4) stored on line number memory 62 of FIG. 4) for multiplexing the first metadata into the stream data, and a second multiplexing condition (for example, another one of multiplexing conditions (H1 through H4) stored on H_ANC/V_ANC memory 61 of FIG. 4 or another one of multiplexing conditions (L1 through L4) stored on line number memory 62 of FIG. 4) configured to multiplex the second metadata into the stream data, a multiplex determination unit (for example, comparator 71 in FIG. 4 in meta multiplexer 43 of FIG. 3) configured successively read from the multiplexing condition storage unit the first multiplexing condition and the second multiplexing condition in a predetermined order sequence, and configured to successively determine in the predetermined order sequence whether a predetermined portion of the stream data satisfies one of the first multiplexing condition and the second multiplexing condition, a multiplexing unit (for example, multiplexer 75 in FIG. 4 in meta multiplexer 43 of FIG. 3) configured to multiplex the first metadata with the portion of the stream data that the multiplex determination unit has determined as satisfying the first multiplexing condition, and configured to multiplex the second metadata with the portion of the stream data that the multiplex determination unit has determined as satisfying the second multiplexing condition, and a transmitting unit (for example, SDI output unit 45 of FIG. 3) configured to transmit the stream data into which the multiplexing unit has multiplexed the first metadata and the second metadata.

Each of the first multiplexing condition and the second multiplexing condition may include a first type and a second type (for example, if the multiplexing conditions (H1 through H4) stored on H_ANC/V_ANC memory 61 of FIG. 4 are of the first type, the multiplexing conditions (L1 through L4) stored on line number memory 62 are of the second type). The multiplexing condition storage unit may include a first memory (for example, H_ANC/V_ANC memory 61 of FIG. 4) for storing the first and second multiplexing conditions of the first type, and a second memory (for example, line number memory 62 of FIG. 4) for storing the first and second multiplexing conditions of the second type. The multiplex determination unit may successively read from the multiplexing condition storage unit in the predetermined order sequence the first multiplexing conditions of the first type and the second type and the second multiplexing conditions of the first type and the second type, and successively determine in the predetermined order sequence whether the predetermined portion of the stream data satisfies the first multiplexing conditions of the first type and the second type or the second multiplexing conditions of the first type and the second type. The multiplexing unit may multiplex the first metadata with the portion of the stream data if the multiplex determination unit determines that the portion of the stream data satisfies the first multiplexing conditions of the first type and the second type, and multiplex the second metadata with the portion of the stream data if the multiplex determination unit determines that the portion of the stream data satisfies the second multiplexing conditions of the first type and the second type.

The transmitter may further include an address control unit (for example, read address controller 73 of FIG. 4). The address control unit sets an area of the first memory storing the first multiplexing condition of the first type to a first address (for example, one of a0-a3 of FIG. 4), and an area of the first memory storing the second multiplexing condition of the first type to a second address (for example, another one of a0-a3 of FIG. 4), sets an area of the second memory storing the first multiplexing condition of the second type to the first address and an area of the second memory storing the second multiplexing condition of the second type to the second address, and notifies the multiplex determination unit of the setting content. The multiplex determination unit reads from the multiplexing condition storage unit one of the first multiplexing condition of the first type and the second type and the second multiplexing condition of the first type and the second type in accordance with the setting content of which the address control unit has notified the multiplex determination unit.

The transmitter may further include a memory unit (for example, metadata memory 65, DID memory 63, and SDID memory 64 of FIG. 4) configured to store the first metadata and the second metadata, and a metadata reading unit (for example, metadata selector and reader 74 of FIG. 4) configured to read the first metadata from the memory unit if the multiplex determination unit has determined that the first multiplexing condition is satisfied, and configured to read the second metadata from the memory unit if the multiplex determination unit has determined that the second multiplexing condition is satisfied. The multiplexing unit multiplexes the first metadata read by the metadata reading unit with the portion of the stream data that the multiplex determination unit has determined as satisfying the first multiplexing condition, and multiplexes the second metadata read by the metadata reading unit with the portion of the stream data that the multiplex determination unit has determined as satisfying the second multiplexing condition.

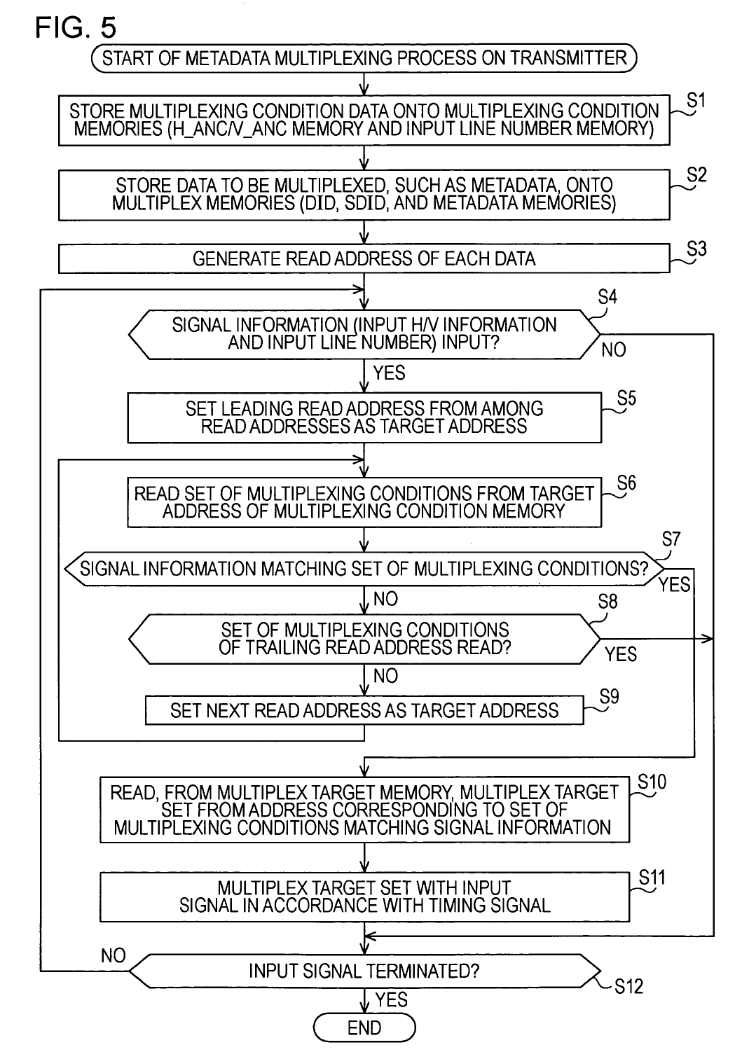

In accordance with embodiments of the present invention, a transmitting method/program include the steps of successively reading the first multiplexing condition and the second multiplexing condition from the memory in a predetermined order sequence, and determining in the predetermined order sequence whether a predetermined portion of the stream data satisfies one of the first multiplexing condition and the second multiplexing condition (for example, process in step S5 and loop process of step S6 through step S9), and multiplexing the first metadata with the portion of the stream data that is determined as satisfying the first multiplexing condition, and multiplexing the second metadata with the portion of the stream that is determined as satisfying the second multiplexing condition (for example, process in steps S10 and S11 of FIG. 5).

A receiver (for example, receiver 32 of FIG. 3) of one embodiment of the present invention for receiving a stream data (for example, signal transmitted by transmitter 31 of FIG. 3) into which first metadata (for example, one unit of metadata (M1 through M4)) stored on metadata memory 85 of FIG. 6) and second metadata (for example, another unit of the metadata (M1 through M4) stored on metadata memory 85) are multiplexed, and extracting the first metadata and the second metadata from the stream data, includes a receiving unit (for example, SDI input unit 51 of FIG. 3) configured to receive the stream data transmitted from the transmitter, an extraction condition storage unit (for example, H_ANC/V_ANC memory 81, line number memory 82, DID memory 83, SDID memory 84, etc. of FIG. 6 in meta extractor 55 of FIG. 3) configured to store a first extraction condition (for example, one of extraction conditions (H1 through H4) stored on H_ANC/V_ANC memory 81 of FIG. 6, one of extraction conditions (L1 through L4) stored on line number memory 82, one of extraction conditions (D1 through D4) stored on DID memory 83, or one of extraction conditions (S1 through S4) stored on SDID memory 84) for extracting the first metadata from the stream data and a second extraction condition (for example, another one of extraction conditions (H1 through H4) stored on H_ANC/V_ANC memory 81 of FIG. 6, another one of extraction conditions (L1 through L4) stored on line number memory 82, another one of extraction conditions (D1 through D4) stored on DID memory 83, or another one of extraction conditions (S1 through S4) stored on SDID memory 84) for extracting the second metadata from the stream data, an extraction determination unit (for example, comparator 91 of FIG. 6 in meta extractor 55 of FIG. 3) configured to read successively the first extraction condition and the second extraction condition in a predetermined order sequence from the extraction condition storage unit and successively determining in the predetermined order sequence whether a predetermined portion of the stream data received by the receiving unit satisfies one of the first extraction condition and the second extraction condition, and an extracting unit (for example, extractor 94 of FIG. 6 in meta extractor 55 of FIG. 3) configured to extract the first metadata from the portion of the stream data received by the receiving unit and determined by the extraction determination unit as satisfying the first extraction condition and extracting the second metadata from the portion of the stream data received by the receiving unit and determined by the extraction determination unit as satisfying the second extraction condition.

Each of the first extraction condition and the second extraction condition includes a first type and a second type (for example, two of the four types including extraction conditions (H1 through H4) stored on H_ANC/V_ANC memory 81 of FIG. 6, extraction conditions (L1 through L4) stored on line number memory 82, extraction conditions (D1 through D4) stored on DID memory 83, and extraction conditions (S1 through S4) stored on SDID memory 84 become the first type and the other two of the four types become the second type). The extraction condition storage unit includes a first memory (for example, one of H_ANC/V_ANC memory 81 of FIG. 6, line number memory 82, DID memory 83, and SDID memory 84 in meta extractor 55 of FIG. 3 storing the extraction condition determined to be of the second type) for storing the first and second extraction conditions of the first type, and a second memory (for example, one of H_ANC/V_ANC memory 81 of FIG. 6, line number memory 82, DID memory 83, and SDID memory 84 in meta extractor 55 of FIG. 3 storing the extraction condition determined to be of the first type) for storing the first and second extraction conditions of the second type. The extraction determination unit successively reads from the extraction condition storage unit in the predetermined order sequence the first extraction conditions of the first type and the second type and the second extraction conditions of the first type and the second type, and successively determines in the predetermined order sequence whether the predetermined portion of the stream data satisfies the first extraction conditions of the first type and the second type or the second extraction conditions of the first type and the second type. The extracting unit extracts the first metadata from the portion of the stream data that the extraction determination unit determines as satisfying the first extraction conditions of the first type and the second type, and extracts the second metadata from the portion of the stream data that the extraction determination unit determines as satisfying the second extraction conditions of the first type and the second type.

The receiver may further include an address control unit (for example, read/write address controller 93 of FIG. 6). The address control unit sets an area of the first memory storing the first extraction condition of the first type to a first address (for example, one of a0-a3 of FIG. 6), and an area of the first memory storing the second extraction condition of the first type to a second address (for example, another one of a0-a3 of FIG. 6), sets an area of the second memory storing the first extraction condition of the second type to the first address and an area of the second memory storing the second extraction condition of the second type to the second address, and notifies the extraction determination unit of the setting content. The extraction determination unit reads from the extraction condition storage unit the first extraction conditions of the first type and the second type or the second extraction conditions of the first type and the second type in accordance with the setting content of which the address control unit has notified.

The receiver may further include a memory unit (for example, metadata memory 85 of FIG. 6) configured to store the first metadata and the second metadata, and a metadata writing unit (for example, metadata selector and writer 95 of FIG. 6) configured to write one of the first metadata and the second metadata extracted by the extracting unit onto the memory unit.

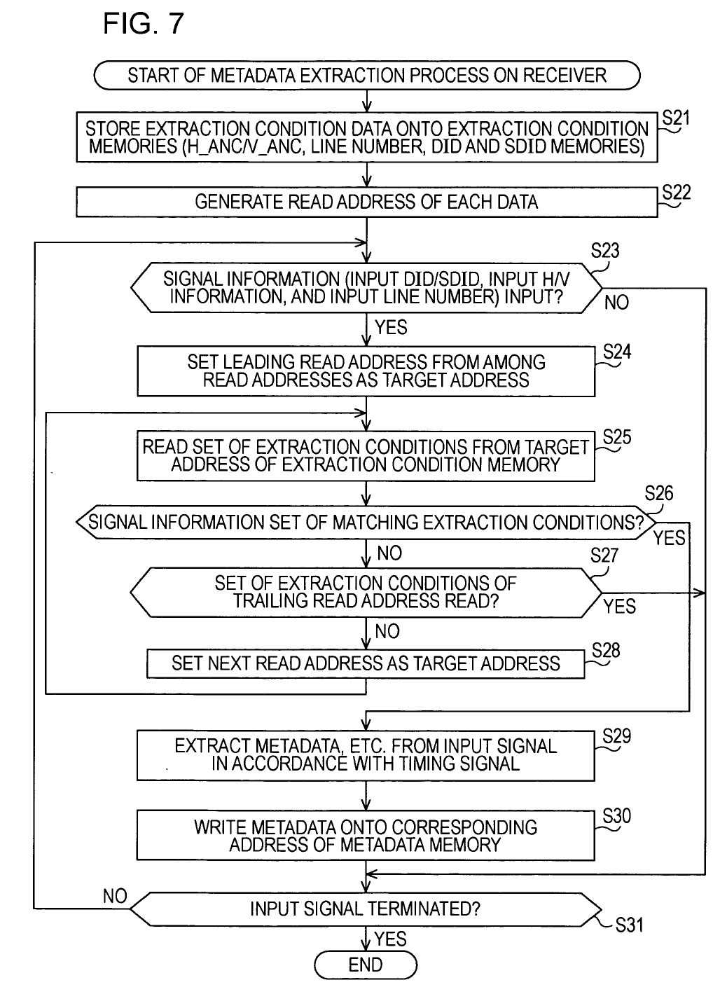

In accordance with embodiments of the present invention, a receiving method/program of a receiver/apparatus includes the steps of successively reading the first extraction condition and the second extraction condition from the memory in a predetermined order sequence, and determining in the predetermined order sequence whether a predetermined portion of the stream data received by the receiver satisfies one of the first extraction condition and the second extraction condition (for example, process in step S24 and loop process in steps S25 through S28 of FIG. 7), and extracting the first metadata from a portion of the stream data received by the receiver and determined as satisfying the first extraction condition, and extracting the second metadata from a portion of the stream data received by the receiver and determined as satisfying the second extraction condition (for example, step S29 of FIG. 7).

The embodiments of the present invention are described below with reference to the drawings.

FIG. 3 illustrates a transmission and reception system of one embodiment of the present invention.

The transmission and reception system of FIG. 3 includes a transmitter 31 for transmitting in the form of a serial signal an HD_SDI signal having metadata MD superimposed thereon and a receiver 32 for receiving the HD_SDI signal.

The transmitter 31 includes a synchronization signal multiplexer 41 through a main controller 47.

The synchronization signal multiplexer 41 multiplexes (superimposes) a synchronization signal generated by the synchronization signal and signal information generator 46 with predetermined video signal, and supplies the resulting signal (hereinafter referred to as synchronization signal multiplexed video data) to an audio multiplexer 42.

The audio multiplexer 42 multiplexes the predetermined audio data A with the synchronization signal multiplexed video data supplied from the synchronization signal multiplexer 41 in accordance with the synchronization signal and the signal information, both generated by the synchronization signal and signal information generator 46. The audio multiplexer 42 supplies the resulting data (hereinafter referred to as AV data) to the meta multiplexer 43.

The signal information supplied to the audio multiplexer 42 by the synchronization signal and signal information generator 46 is compared with a multiplexing condition set by the main controller 47. More specifically, the signal information supplied from the synchronization signal and signal information generator 46 to the audio multiplexer 42 identifies a predetermined location of the synchronization signal multiplexed video data. The predetermined audio signal A is multiplexed onto a portion of the synchronization signal multiplexed video data identified by the signal information matching the multiplexing condition.

In accordance with the synchronization signal and the signal information generated by the synchronization signal and signal information generator 46, the meta multiplexer 43 multiplexes metadata MD supplied via the main controller 47 onto the AV data supplied from the audio multiplexer 42, and supplies the resulting data (hereinafter referred to as metadata multiplexed AV data) to a P/S converter 44.

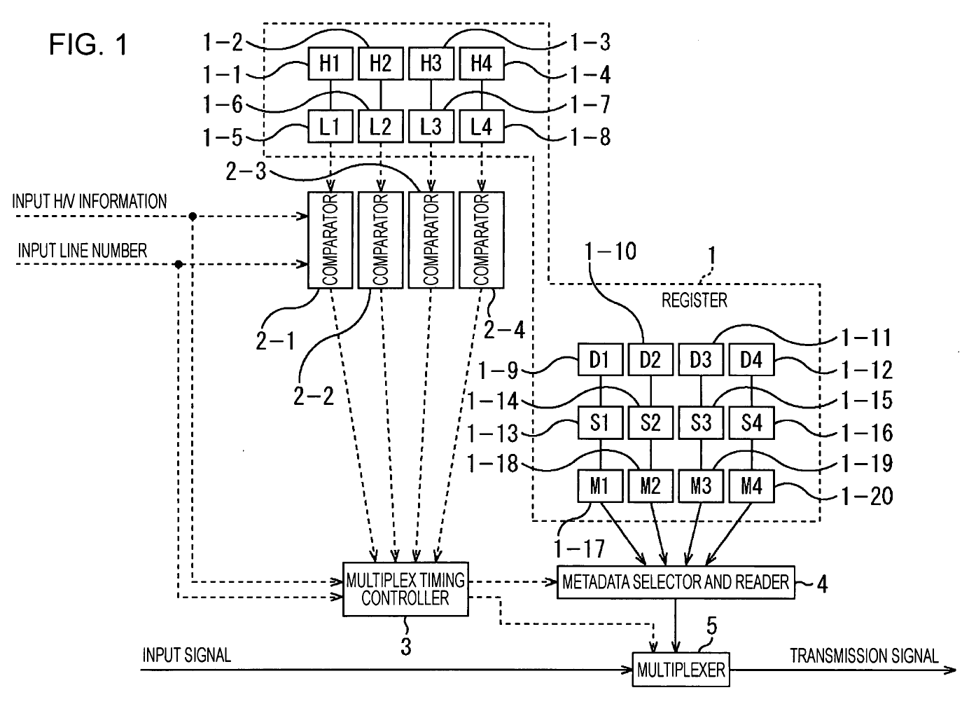

The signal information supplied from the synchronization signal and signal information generator 46 to the meta multiplexer 43 is to be compared with a multiplexing condition generated by the main controller 47. In this embodiment corresponding to the known meta multiplexer of FIG. 1, a set of H_ANC/V_ANC period and the Line_Number is adopted as a multiplexing condition and a set of input H/V information and Line_Number is adopted as the signal information. The predetermined metadata MD is multiplexed onto the portion of the AV data identified by the signal information matching these multiplexing conditions.

The meta multiplexer 43 is described in detail with reference to FIG. 4, and the operation of the meta multiplexer 43 is described in detail below with reference to FIG. 5.

The metadata multiplexed AV data supplied from the meta multiplexer 43 to the parallel-to-serial (P/S) converter 44 takes a parallel signal form. The P/S converter 44 thus converts the metadata multiplexed AV data in the form thereof from a parallel signal to a serial signal, and then outputs the serial signal to the SDI output unit 45.

The SDI output unit 45 outputs (transmits) the metadata multiplexed AV data in the serial signal form output by the P/S converter 44.

The synchronization signal and signal information generator 46 generates the synchronization signal and the variety of signal information as described above.

The main controller 47 generally controls the operation of the transmitter 31. As described above, the main controller 47 acquires and then supplies the metadata MD, and sets a variety of multiplexing conditions to the audio multiplexer 42 and the meta multiplexer 43.

The operation of the transmitter 31 is described below.

The transmitter 31 multiplexes the synchronization signal, the audio data A, and the metadata MD in addition to the video data V, thereby resulting in the metadata multiplexed AV data in the parallel signal form. The metadata multiplexed AV data is then converted in form from the parallel signal to the serial signal. The resulting serial signal is supplied as a SDI signal to the receiver 32.

The operation of the meta multiplexer 43 will be described later with reference to FIG. 5.

The receiver 32, which receives the SDI signal transmitted from the transmitter 31 (metadata multiplexed AV data in the serial signal form), includes an SDI input unit 51 through a main controller 56 as shown in FIG. 3.

The SDI input unit 51 receives the SDI signal from the transmitter 31 (metadata multiplexed AV data in the serial signal form), and supplies the received signal to the serial-to-parallel (S/P) converter 52.

The S/P converter 52 converts the signal form of the metadata multiplexed AV data from serial to parallel, and then outputs the resulting parallel signal.

The synchronization signal and signal information extractor 53 extracts the synchronization signal and the variety of signal information from the metadata multiplexed AV data output from the S/P converter 52 and then supplies the extracted data to the audio extractor 54 and the meta extractor 55.

In accordance with the synchronization signal and the signal information supplied from the synchronization signal and signal information extractor 53, the audio extractor 54 extracts the audio data A from the metadata multiplexed AV data output from the S/P converter 52.

The signal information supplied from the synchronization signal and signal information extractor 53 to the audio extractor 54 is to be compared with an extraction condition set by the main controller 56. More specifically, the signal information supplied from the synchronization signal and signal information extractor 53 to the audio extractor 54 is to identify a predetermined portion of the metadata multiplexed AV data output from the S/P converter 52. The audio data A has thus been multiplexed on a portion of the metadata multiplexed AV data identified by the signal information matching the extraction condition. The audio data A can thus be extracted from that portion.

In accordance with the synchronization signal and the variety of information supplied from the synchronization signal and signal information extractor 53, the meta extractor 55 extracts the metadata MD from the metadata multiplexed AV data output from the S/P converter 52 and then supplies the extracted metadata MD to the main controller 56.

The signal information supplied from the synchronization signal and signal information extractor 53 to the meta extractor 55 is to be compared with an extraction condition set by the main controller 56. In this embodiment corresponding to the known meta extractor of FIG. 1, a set of H_ANC/V_ANC period, Line_Number, DID, and SDID is adopted as an extraction condition and a set of input DID/SDID, input H/V information and Line_Number is adopted as the signal information. It is thus learned that the metadata MD has been multiplexed on a portion of the metadata multiplexed AV data identified by the signal information matching the extraction condition. The metadata MD can thus be extracted from that portion.

The meta extractor 55 is described below with reference to FIG. 6, and the operation of the meta extractor 55 is described below with reference to FIG. 7.

The main controller 56 generally controls the operation of the receiver 32. As previously discussed, the main controller 56 acquires the metadata MD extracted by the meta extractor 55, outputs the acquired metadata MD, and sets a variety of extraction conditions on the audio extractor 54 and the meta extractor 55.

The operation of the receiver 32 is described below.

Upon receipt of the SDI signal transmitted from the transmitter 31 (metadata multiplexed AV data), the receiver 32 serial-to-parallel converts the form of the metadata multiplexed AV data. The video data V, the audio data A, and the metadata MD are demultiplexed from multiplexed AV data in the parallel signal form, and then output.

The operation of the meta extractor 55 will be described in detail later with reference to FIG. 7.

The meta multiplexer 43 is described herein in detail with reference to FIGS. 4 and 5. FIG. 4 is a block diagram illustrating the details of the meta multiplexer 43. FIG. 5 is a flowchart mainly illustrating the process of the meta multiplexer 43 (hereinafter referred to as transmitter side metadata multiplexing process).

For convenience of comparison with the known meta multiplexer of FIG. 1, the meta multiplexer 43 of FIG. 4 uses the first through fourth multiplexing conditions used in the discussion of the known art of FIG. 1, and the first through fourth multiplex targets used in the known art of FIG. 1 are used as data to be multiplexed onto the input signal.

However, it should be noted that the first through fourth multiplexing conditions and the first and through fourth multiplex targets are stored on memories in the meta multiplexer 43 of FIG. 4 rather than on the registers. The first through fourth multiplexing condition sets are successively referenced (this method is hereinafter referred to as memory-mapping method).

As shown in FIG. 4, the meta multiplexer 43 includes, as such memories, an H_ANC/V_ANC memory 61, a line number memory 62, a DID memory 63, a SDID memory 64, and a metadata memory 65.

The H_ANC/V_ANC memory 61 stores four H_ANC/V_ANC periods (H1 through H4) respectively belonging to the first through fourth multiplexing condition sets. The storage operation of the four H_ANC/V_ANC periods (H1 through H4) is performed by the main controller 47 (in step S1 of FIG. 5). Read addresses of the four H_ANC/V_ANC periods (H1 through H4) are set (generated) by a read address controller 73 (in step S3 of FIG. 5 to be discussed later). As shown in FIG. 4, the read addressed of the four H_ANC/V_ANC periods (H1 through H4) are a0, a1, a2, and a3, respectively.

In this specification, the storage of the data representing the multiplexing conditions onto the memories (the registers in the known art) is also referred to as “set.” More specifically, “the main controller 47 sets the four H_ANC/V_ANC periods (H1 through H4) onto the H_ANC/V_ANC memory 61” means that “the main controller 47 controls the storage of the four H_ANC/V_ANC periods (H1 through H4) onto the H_ANC/V_ANC memory 61.”

The line number memory 62 stores four line numbers (L1 through L4) respectively belonging the first through fourth multiplexing condition sets. The setting of the four line numbers (L1 through L4) is performed by the main controller 47 (in step S1 of FIG. 5 to be discussed later). Read addresses of the four line numbers (L1 through L4) are generated by the read address controller 73 (in step S3 of FIG. 5 to be discussed later). As shown in FIG. 4, the read addresses of the four line numbers (L1 through L4) are a0, a1, a2, and a3, respectively.

In this embodiment, one type (of the two types of multiplexing condition data such as H_ANC/V_ANC period and Line_Number of FIG. 4) forming the multiplexing condition sets is stored on one memory. The number of types of multiplexing condition data stored on one memory is not limited to one and may be two or more. However, the storage of one type of multiplexing condition data on one memory is preferable. A comparator 71 performs a comparison process on a per multiplexing condition set basis. If two or more types of multiplexing condition data forming the multiplexing condition sets are stored on one memory, it is difficult to simultaneously read two or more types of multiplexing condition data at a time, and it is necessary to read two or more types of the multiplexing condition data in a predetermined order from one memory (for example, in the order from small to large read address values), and the comparison process takes a longer time. In other words, since two or more types of multiplexing condition data forming the multiplexing condition sets are stored on separate memories in this embodiment, the reading of the two or more types of multiplexing condition data can be read substantially at the same time. As a result, the comparison process is performed more quickly.

Memories storing particular type of the multiplexing condition data forming the multiplexing condition sets are referred to as multiplexing condition memories. The multiplexing condition memories herein are the H_ANC/V_ANC memory 61 and the line number memory 62 as shown in FIG. 4.

Memories storing predetermined types of data forming the multiplex target sets (three types of data DID, SDID, and metadata in FIG. 4) are referred to as multiplex target memories. The multiplex target memories in FIG. 4 are the DID memory 63, the SDID memory 64, and the metadata memory 65.

The DID memory 63 stores four DIDs (D1 through D4) belonging to the first through fourth multiplex target sets, respectively. The setting of the four DIDs (D1 through D4) is performed by the main controller 47 (in step S2 of FIG. 5). Read addresses of the four DIDs (D1 through D4) are generated by the read address controller 73 (in step S3 of FIG. 5). The read addresses of the four DIDs (D1 through D4) are a0, a1, a2, and a3, respectively.

The SDID memory 64 stores four SDIDs (S1 through S4) respectively belonging to the first through fourth multiplex target sets. The setting operation of the four SDIDs (S1 through S4) is performed by the main controller 47 (in step S2 of FIG. 5). Read addresses of the four SDIDs (S1 through S4) are generated by the read address controller 73 (in step S3 of FIG. 5). The read addresses of the four SDIDs (S1 through S4) in FIG. 4 are a0, a1, a2, and a3, respectively.

The metadata memory 65 stores four units of metadata MD (M1 through M4) respectively belonging to the first through fourth multiplex target sets. The setting operation of the four units of metadata (M1 through M4) is performed by the main controller 47 (in step S2 of FIG. 5). Read addresses of the four units of metadata (M1 through M4) are generated by the read address controller 73 (in step S3 of FIG. 5). The read addresses of the four units of metadata (M1 through M4) in FIG. 4 are a0, a1, a2, and a3, respectively.

As the multiplexing condition memories, only one type of data forming the multiplex target sets (three types of data of DID, SDID, and metadata in FIG. 4) is stored on one multiplex target memory. The number of types of data stored on one multiplex target memory is not limited to one, and two or more types of data may be stored on one multiplex target memory. However, the storage of one type of data on one multiplex target memory is preferable. The metadata selector and reader 74 performs a read operation on a per multiplex target set. If two or more types of data forming the multiplex target sets are stored on one multiplex target memory, it is difficult to simultaneously read two or more types of data from one multiplex target memory at a time, and it is necessary to read the two or more types of data from one multiplex target memory in a predetermined order (in the order from small to large read address values). The read operation takes more time. Since the two or more types of data forming the multiplex target set are stored on respective separate multiplex target memories in this embodiment, the two or more types of data can be read substantially at the same time. As a result, the time required for the read operation is shortened.

For convenience of comparison with the known meta multiplexer of FIG. 1, the number of types of the metadata is four, namely, M1 through M4. The number of types of metadata is not limited as long as the memory capacity of each memory is sufficient to store the metadata. If the number of types of metadata increases, increased metadata and multiplexing condition data corresponding to the increased metadata are simply stored on the corresponding memories.

The comparator 71 receives the input H/V information and the input Line No. from the synchronization signal and signal information generator 46 of FIG. 3. As represented by a large arrow in FIG. 4, the comparator 71 successively reads the first through fourth multiplexing condition sets and determines whether the read first through fourth multiplexing condition sets match the set of the input H/V information and the input Line No. and supplies the determination results to the multiplex timing controller 72.

The successive reading of the first through fourth multiplexing condition sets includes the following process steps.

The read addresses of the four H_ANC/V_ANC periods (H1 through H4) and the four Line Numbers (L1 through L4) forming the first through fourth multiplexing condition sets are generated by the read address controller 73 as described above. More specifically, the read addresses of the four H_ANC/V_ANC periods (H1 through H4) in the H_ANC/V_ANC memory 61 are a0, a1, a2, and a3, respectively, as shown in FIG. 4, and the comparator 71 is notified of the read addresses. The read addresses of the four line numbers (L1 through L4) on the line number memory 62 are a0, a1, a2, and a3, respectively, and the comparator 71 is also notified of the read addresses.

The comparator 71 reads data from the address a0 of each of the H_ANC/V_ANC memory 61 and the line number memory 62. The first multiplex set, namely, the set of the H_ANC/V_ANC period (H1) and the line number (L1), is read. The comparator 71 determines whether the first multiplexing condition set matches the set of the H_ANC/V_ANC period (H1) and the line number (L1).

If the two sets match each other, the comparator 71 notifies the multiplex timing controller 72 of the determination results. In this case, the comparator 71 does not perform the read operation to the subsequent multiplexing condition set. Data to be multiplexed on a portion identified by the input H/V information and the input Line No. of the input signal is the first multiplex target set (metadata (M1)) corresponding to the first multiplexing condition set.

If it is determined that the two sets fail to match each other, the comparator 71 reads data from the address a1 of each of the H_ANC/V_ANC memory 61 and the line number memory 62. The second multiplexing condition set, namely, H_ANC/V_ANC period (H2) and line number (L2), are thus read. The comparator 71 determines whether the second multiplexing condition set matches the set of input H/V information and the input Line No.

If the two sets match each other, the comparator 71 notifies the multiplex timing controller 72 of the determination results. In this case, the comparator 71 does not perform the read operation to the subsequent multiplexing condition set. Data to be multiplexed on a portion identified by the input H/V information and the input Line No. of the input signal is the second multiplex target set (metadata (M2)) corresponding to the second multiplexing condition set.

If it is determined that the two sets fail to match each other, the comparator 71 reads data from the address a2 of each of the H_ANC/V_ANC memory 61 and the line number memory 62. The third multiplexing condition set, namely, H_ANC/V_ANC period (H3) and line number (L3), are thus read. The comparator 71 determines whether the third multiplexing condition set matches the set of input H/V information and the input Line No.

If the two sets match each other, the comparator 71 notifies the multiplex timing controller 72 of the determination results. In this case, the comparator 71 does not perform the read operation to the subsequent multiplexing condition set. Data to be multiplexed on a portion identified by the input H/V information and the input Line No. of the input signal is the third multiplex target set (metadata (M3)) corresponding to the third multiplexing condition set.

If it is determined that the two sets fail to match each other, the comparator 71 reads data from the address a3 of each of the H_ANC/V_ANC memory 61 and the line number memory 62. The fourth multiplexing condition set, namely, H_ANC/V_ANC period (H4) and line number (L4), are thus read. The comparator 71 determines whether the fourth multiplexing condition set matches the set of input H/V information and the input Line No.

If the two sets match each other, the comparator 71 notifies the multiplex timing controller 72 of the determination results. In this case, the comparator 71 does not perform the read operation to the subsequent multiplexing condition set. Data to be multiplexed on a portion identified by the input H/V information and the input Line No. of the input signal is the fourth multiplex target set (metadata (M4)) corresponding to the fourth multiplexing condition set.

If it is determined that the two sets fail to match each other, the comparator 71 notifies the multiplex timing controller 72 of the determination results. In this case, no metadata is to be multiplexed on a portion identified by the input H/V information and the input Line No. of the input signal.

The comparator 71 performs the above-described series of process steps, and the process results (determination results) are provided to the multiplex timing controller 72.

Based on the determination results from the comparator 71 and the input H/V information and the input Line No. from the synchronization signal and signal information generator 46, the multiplex timing controller 72 generates the selection signal specifying which of the first through fourth multiplex target sets to multiplex and the timing signal at which the multiplex target set is to be multiplexed onto the input signal. The multiplex timing controller 72 supplies the selection signal to the metadata selector and reader 74 and the timing signal to the multiplexer 75.

The multiplex timing controller 72 supplies the input H/V information and the input Line No. from the synchronization signal and signal information generator 46 to the read address controller 73.

The read address controller 73 generates the read addresses in the multiplexing condition memories (the H_ANC/V_ANC memory 61 and the line number memory 62) and the multiplex target memory (the DID memory 63, the SDID memory 64, and the metadata memory 65) as described above while referencing the set of the input H/V information and the input Line No. from the multiplex timing controller 72. The multiplex timing controller 72 then supplies, out of the generation results, the read addresses in the multiplexing condition memories to the comparator 71, and the read addresses in the multiplex target memories to the metadata selector and reader 74.

The metadata selector and reader 74 reads from the multiplex target memories (the DID memory 63, the SDID memory 64 and the metadata memory 65) the set specified by the selection signal from the multiplex timing controller 72, and supplies the read set to the multiplexer 75.

More specifically, when the selection signal from the multiplex timing controller 72 specifies the first multiplex target set, the metadata selector and reader 74 identifies, as the address of the first multiplex target set, the a0 of the addresses of which the read address controller 73 has notified. The metadata selector and reader 74 reads data from the address a0 of each of the DID memory 63, the SDID memory 64 and the metadata memory 65, and supplies the multiplexer 75 with the read data. In this way, the first multiplex target set, namely, the DID (D1), the SDID (S1), and the metadata (M1) are supplied to the multiplexer 75.

When the selection signal from the multiplex timing controller 72 specifies the second multiplex target set, the metadata selector and reader 74 identifies, as the address of the second multiplex target set, the a1 of the addresses of which the read address controller 73 has notified. The metadata selector and reader 74 reads data from the address a1 of each of the DID memory 63, the SDID memory 64 and the metadata memory 65, and supplies the multiplexer 75 with the read data. In this way, the second multiplex target set, namely, the DID (D2), the SDID (S2), and the metadata (M2) are supplied to the multiplexer 75.

When the selection signal from the multiplex timing controller 72 specifies the third multiplex target set, the metadata selector and reader 74 identifies, as the address of the third multiplex target set, the a2 of the addresses of which the read address controller 73 has notified. The metadata selector and reader 74 reads data from the address a2 of each of the DID memory 63, the SDID memory 64 and the metadata memory 65, and supplies the multiplexer 75 with the read data. In this way, the third multiplex target set, namely, the DID (D3), the SDID (S3), and the metadata (M3) are supplied to the multiplexer 75.

When the selection signal from the multiplex timing controller 72 specifies the fourth multiplex target set, the metadata selector and reader 74 identifies, as the address of the fourth multiplex target set, the a3 of the addresses of which the read address controller 73 has notified. The metadata selector and reader 74 reads data from the address a3 of each of the DID memory 63, the SDID memory 64 and the metadata memory 65, and supplies the multiplexer 75 with the read data. In this way, the fourth multiplex target set, namely, the DID (D4), the SDID (S4), and the metadata (M4) are supplied to the multiplexer 75.

The multiplexer 75 receives the AV data output from the audio multiplexer 42 of FIG. 3 as an input signal. In response to the timing signal from the multiplex timing controller 72, the multiplexer 75 multiplexes an m-th multiplex target set supplied from the metadata selector and reader 74 (m is an integer falling within a range of 1 through 4), namely, DID (Dm), SDID (Sm), and metadata (Mm) onto a corresponding portion of the input signal (a portion identified by the set of the input H/V information and the input Line No. input to the comparator 71), and supplies the resulting signal (a portion of the metadata multiplexed AV data in the parallel signal form) to the P/S converter 44 of FIG. 3 as an output signal.

The process of the meta multiplexer 43 of FIG. 4 thus constructed, namely, the transmitter side metadata multiplex process is described below with reference to a flowchart of FIG. 5.

Steps S1 and S2 are performed by the main controller 47 of FIG. 3.

In step S, the main controller 47 stores (sets) the multiplexing condition data onto the multiplexing condition memories (the H_ANC/V_ANC memory 61 and the line number memory 62).

In step S2, the main controller 47 stores the data of the multiplex target data such as the metadata onto the multiplex target memories (the DID memory 63, the SDID memory 64, and the metadata memory 65).

The order of execution of steps S1 and S2 is not limited to any particular one. More specifically, step S2 may be performed followed by step S1. Alternatively, steps S1 and S2 may be performed substantially at the same time.

In step S3, the read address controller 73 generates the read address of each data.

In step S4, the comparator 71 determines whether the signal information (the input H/V information and the input Line No.) has been input.

If it is determined in step S4 that the signal information has not been input, processing proceeds to step S12. Step S12 and subsequent steps will be described later.

If it is determined in step S4 that the signal information has been input, processing proceeds to step S5. In step S5, the comparator 71 sets the leading address (a0 in FIG. 4) from among the read addresses (a0-a3 in FIG. 4) as a target address.

In step S6, the comparator 71 reads a set of multiplexing conditions from the target addresses of the multiplexing condition memories.

In step S7, the comparator 71 determines whether the signal information matches the set of multiplexing conditions read in the immediately preceding step S6.

If it is determined in step S7 that the signal information matches the set of multiplexing conditions, processing proceeds to step S10. Step S10 and subsequent steps will be described later.

If it is determined in step S7 that the signal information fails to match the set of multiplexing conditions, processing proceeds to step S8. In step S8, the comparator 71 determines whether the set of multiplexing conditions of the trailing read address (a3 in FIG. 4) has been read.

If it is determined in step S8 that the set of multiplexing conditions of the trailing read address has been read, processing proceeds to step S12. Step S12 and subsequent steps will be described later.

If it is determined in step S8 that the set of multiplexing conditions of the trailing read address has not been read, processing proceeds to step S9. In step S9, the comparator 71 sets a next address as a target address. More specifically, the series of steps performed by the comparator 71 (read process of successively reading the sets of multiplexing conditions from the memories) is performed as a loop process of step S6 through S9.

Now, a k-th set of multiplexing conditions (k falls within a range from 1 through 4) may match the signal information. The determination in step S7 in the k-th loop process from step S6 through step S9 is yes, and processing proceeds to step S10. More precisely, through the determination in step S7, the comparator 71 supplies the multiplex timing controller 72 with the determination result that the signal information matches the k-th multiplexing condition set. In response, the multiplex timing controller 72 generates a selection signal specifying the selection of the k-th multiplex target set corresponding to the k-th multiplexing condition set and a timing signal indicating the timing at which the k-th multiplex target set is to be multiplexed with the input signal. The multiplex timing controller 72 supplies the selection signal to the metadata selector and reader 74 and the timing signal to the multiplexer 75. Processing proceeds to step S10.

In step S10, the metadata selector and reader 74 reads a multiplex target set (the k-th multiplex target set herein) from the read address of the multiplexing condition set matching the signal information (a(k−1) as the read address of the k-th multiplexing condition set), and then supplies the read multiplexing condition set to the multiplexer 75.

Through the process in step S10, DID(Dk) and SDID(Sk), and metadata(Mk) are read from the multiplex target memories. When DID(Dk) and SDID(Sk), and metadata(Mk) are supplied to the multiplexer 75, processing proceeds to step S11.

In step S11, the multiplexer 75 multiplexes the k-th multiplex target set (namely, DID(Dk), SDID(Sk), and metadata(Mk)) onto the input signal (more precisely, a portion identified by the signal information input in the preceding step S4).

In step S12, the meta multiplexer 43 determines whether the input signal has been input (with the last portion thereof already input).

If it is determined in step S12 that the input of the input signal has not been completed (with the last portion thereof not yet input), processing returns to step S4 to repeat step S4 and subsequent steps.

If it is determined in step S12 that the input of the input signal has been completed (with the last portion thereof already input), the transmitter side metadata multiplex process ends.

The meta multiplexer 43 of FIG. 3 has been discussed in detail with reference to FIGS. 4 and 5.

The meta extractor 55 of FIG. 3 is described below with reference to FIGS. 6 and 7. FIG. 6 is a block diagram illustrating the details of the meta extractor 55. FIG. 7 is a flowchart mainly illustrating a process of the meta extractor 55 (hereinafter referred to as receiver side metadata extraction process).

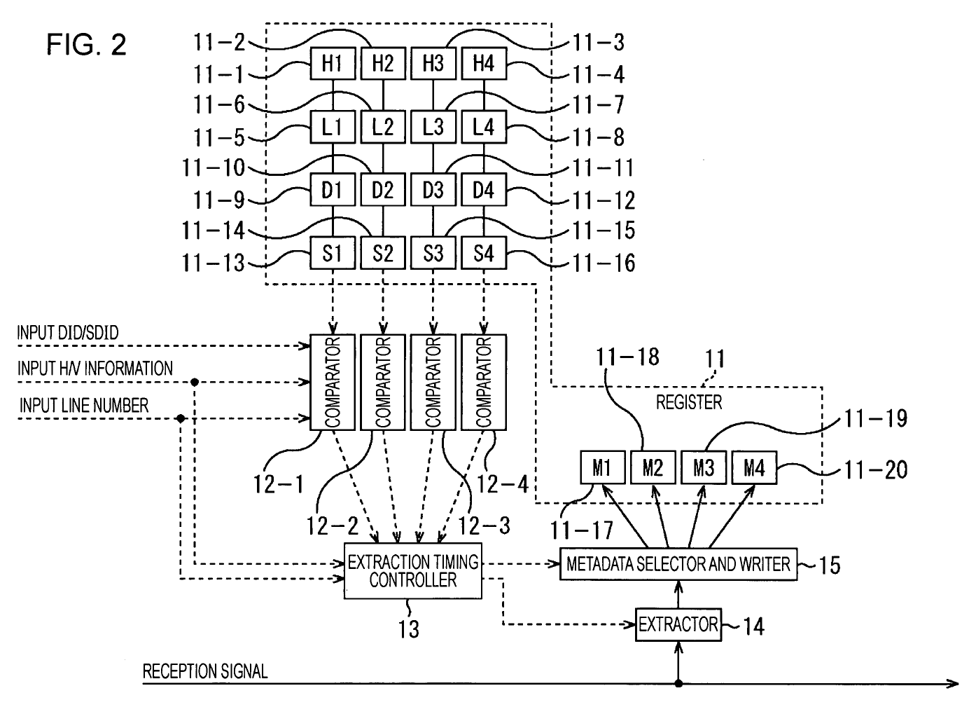

To facilitate comparison with the known meta extractor of FIG. 2, the meta extractor 55 of FIG. 6 adopts the first through fourth extraction condition sets used in the known example of FIG. 2, and the first through fourth multiplex target sets used in the known example of FIG. 2 are used as data multiplexed onto the input signal. More specifically, the meta extractor 55 of FIG. 6 is an example corresponding to the above-described meta multiplexer 43 of FIG. 4.

However, it should be noted that the first through fourth extraction conditions and the extracted data are stored on memories rather than on the registers. The first through fourth extraction condition sets are successively referenced in the memory-mapping method.

The meta extractor 55 of FIG. 6 includes an H_ANC/V_ANC memory 81, a line number memory 82, a DID memory 83, a SDID memory 84, and a metadata memory 85.

The H_ANC/V_ANC memory 81 stores four H_ANC/V_ANC periods (H1 through H4) respectively belonging to the first through fourth extraction condition sets. The setting operation of the four H_ANC/V_ANC periods (H1 through H4) is performed by the main controller 56 (in step S21 of FIG. 7 to be described later). Read addresses of the four H_ANC/V_ANC periods (H1 through H4) are generated (set) by the read/write address controller 93 (in step S22 of FIG. 7 to be described later). As shown in FIG. 6, the read addresses of the four H_ANC/V_ANC periods (H1 through H4) are a0 through a3, respectively.

The line number memory 82 stores four line numbers (L1 through L4) respectively belonging to the first through fourth extraction condition sets. The setting operation of the four line numbers (L1 through L4) is performed by the main controller 56 (in step S21 of FIG. 7 to be discussed later). Read addresses of the four line numbers (L1 through L4) are generated by the read/write address controller 93 (in step S22 of FIG. 7). As shown in FIG. 6, the read addresses of the four line numbers (L1 through L4) are a0 through a3, respectively.

The DID memory 83 stores four DIDs (D1 through D4) respectively belonging to the first through fourth extraction condition sets. The setting operation of the four DIDs (D1 through D4) is performed by the main controller 56 (in step S21 of FIG. 7). Read addresses of the four DIDs (D1 through D4) are generated by the read/write address controller 93 (in step S22 of FIG. 7). As shown in FIG. 6, the read addresses of the four DIDs (D1 through D4) are a0 through a3, respectively.

The SDID memory 84 stores four SDIDs (S1 through S4) respectively belonging to the first through fourth extraction condition sets. The setting operation of the four SDIDs (S1 through S4) is performed by the main controller 56 (in step S21 of FIG. 7). Read addresses of the four SDIDs (S1 through S4) are generated by the read/write address controller 93 (in step S22 of FIG. 7). As shown in FIG. 6, the read addresses of the four SDIDs (S1 through S4) are a0 through a3, respectively.

In this embodiment, only one type of extraction condition data forming the extraction condition sets (such H_ANC/V_ANC period, line number, DID and SDID in FIG. 4) is stored on one memory. The number of types of extraction condition data stored on one memory is not limited to one and may be two or more. However, the storage of one type of extraction condition data on one memory is preferable. A comparator 91 to be described later performs a comparison process on a per extraction condition set basis. If two types or more of extraction condition data forming the extraction condition sets are stored on one memory, it is difficult to simultaneously read two or more types of extraction condition data at a time, and it is necessary to read two or more types of the extraction condition data in a predetermined order from one memory (for example, in the order from small to large read address values), and the comparison process takes a longer time. In other words, since two or more types of extraction condition data forming the extraction condition sets are stored on separate memories in this embodiment, the reading of the two or more types of extraction condition data can be read substantially at the same time. As a result, the comparison process is performed more quickly.

Memories storing particular type of the extraction condition data forming the extraction condition sets are referred to as extraction condition memories. The extraction condition memories herein in FIG. 6 are the H_ANC/V_ANC memory 81, the line number memory 82, the DID memory 83, and the SDID memory 84.

The metadata memory 85 stores the extracted metadata (M1 through M4 in FIG. 6). The storage (write) operation of the metadata is performed by the metadata selector and writer 95 (in step S30 of FIG. 7). The reading operation of the metadata is performed by the main controller 56.

For convenience of comparison with the known meta extractor of FIG. 2, the types of the metadata is four, namely, M1 through M4. The number of types of metadata is not limited as long as the memory capacity of each memory is sufficient to store the metadata. If the number of types of metadata increases, increased metadata and extraction condition data corresponding to the increased metadata are simply stored on the corresponding memories.

The comparator 91 receives the set of the input DID/SDID, the input H/V information, and the input Line No. from the synchronization signal and signal information extractor 53. As represented by an arrow of FIG. 6, the comparator 91 successively reads the first through fourth extraction condition sets, determines whether the read set matches the set of the input DID/SDID, the input H/V information, and the input Line No. and supplies the determination results to an extraction timing controller 92.

The successive reading operation of the first through fourth extraction condition sets includes the following series of process steps.

The read/write address controller 93 has generated the read addresses of the four H_ANC/V_ANC periods (H1 through H4), the four line number (L1 through L4), the four DIDs (D1 through D4) and the four SDIDs (S1 through S4) forming the first through fourth extraction condition sets and notified the comparator 91 of the generated read addresses. More specifically, as shown in FIG. 6, the read addresses of the four H_ANC/V_ANC periods (H1 through H4) on the H_ANC/V_ANC memory 81 are a0 through a3, respectively, and the comparator 91 is notified of the read addresses a0 through a3. The read addresses of the four line numbers (L1 through L4) on the line number memory 82 are a0 through a3, respectively, and the comparator 91 is notified of the read addresses a0 through a3. The read addresses of the four DIDs (D1 through D4) on the DID memory 83 are a0 through a3, respectively, and the comparator 91 is notified of the read addresses a0 through a3. The read addresses of the four SDIDs (S1 through S4) on the SDID memory 84 are a0 through a3, respectively, and the comparator 91 is notified of the read addresses a0 through a3.

The comparator 91 reads data from the address a0 of each of the H_ANC/V_ANC memory 81, the line number memory 82, the DID memory 83, and the SDID memory 84. The first extraction condition set, namely, the H_ANC/V_ANC period (H1), the line number (L1), the DID (D1), and the SDID (S1), are read. The comparator 91 determines whether the first extraction condition set matches the input DID/SDID, the input H/V information and the input line number.

If the two sets match each other, the comparator 91 notifies the extraction timing controller 92 of the determination results. In this case, the comparator 91 does not perform the reading process to the subsequent extraction condition set. The data multiplexed on the portion identified by the input H/V information and the input line number of the input signal is the first multiplex target set (metadata (M1)) corresponding to the first extraction condition set and the metadata (M1) is then extracted.

If it is determined that the two sets fail to match each other, the comparator 91 reads data from the address a1 of each of the H_ANC/V_ANC memory 81, the line number memory 82, the DID memory 83, and the SDID memory 84. The second extraction condition set, namely, the H_ANC/V_ANC period (H2), the line number (L2), the DID (D2), and the SDID (S2), are read. The comparator 91 determines whether the second extraction condition set matches the input DID/SDID, the input H/V information and the input line number.

If the two sets match each other, the comparator 91 notifies the extraction timing controller 92 of the determination results. In this case, the comparator 91 does not perform the reading process to the subsequent extraction condition set. The data multiplexed on the portion identified by the input H/V information and the input line number of the input signal is the second multiplex target set (metadata (M2)) corresponding to the second extraction condition set and the metadata (M2) is then extracted.

If it is determined that the two sets fail to match each other, the comparator 91 reads data from the address a2 of each of the H_ANC/V_ANC memory 81, the line number memory 82, the DID memory 83, and the SDID memory 84. The third extraction condition set, namely, the H_ANC/V_ANC period (H3), the line number (L3), the DID (D3), and the SDID (S3), are read. The comparator 91 determines whether the third extraction condition set matches the input DID/SDID, the input H/V information and the input line number.

If the two sets match each other, the comparator 91 notifies the extraction timing controller 92 of the determination results. In this case, the comparator 91 does not perform the reading process to the subsequent extraction condition set. The data multiplexed on the portion identified by the input H/V information and the input line number of the input signal is the third multiplex target set (metadata (M3)) corresponding to the third extraction condition set and the metadata (M3) is then extracted.

If it is determined that the two sets fail to match each other, the comparator 91 reads data from the address a3 of each of the H_ANC/V_ANC memory 81, the line number memory 82, the DID memory 83, and the SDID memory 84. The fourth extraction condition set, namely, the H_ANC/V_ANC period (H4), the line number (L4), the DID (D4), and the SDID (S4), are read. The comparator 91 determines whether the fourth extraction condition set matches the input DID/SDID, the input H/V information and the input line number.

If the two sets match each other, the comparator 91 notifies the extraction timing controller 92 of the determination results. The data multiplexed on the portion identified by the input H/V information and the input line number of the input signal is the fourth multiplex target set (metadata (M4)) corresponding to the fourth extraction condition set and the metadata (M4) is then extracted.

If it is determined that the two sets fail to match each other, the comparator 91 notifies the extraction timing controller 92 of the determination results. It is considered that no metadata has been multiplexed on the portion identified by the input H/V information and the input line number of the input signal, and the metadata extraction process of the extractor 94 is inhibited.

The above-referenced series of process steps is performed by the comparator 91 and the process result is supplied to the extraction timing controller 92.

Based on the determination results of the comparator 91 and the input H/V information and the input line number from the synchronization signal and signal information extractor 53, the extraction timing controller 92 generates a selection signal specifying the selection of the metadata identified any of the first through fourth extraction condition sets and a timing signal indicating the timing at which the metadata is to be extracted. The extraction timing controller 92 supplies the selection signal to the metadata selector and writer 95 and the timing signal to the extractor 94.

The extraction timing controller 92 supplies the set of the input H/V information and the input line number from the synchronization signal and signal information extractor 53 to the read/write address controller 93.

The read/write address controller 93 generates the read addresses of the H_ANC/V_ANC memory 81, the line number memory 82, the DID memory 83, and the SDID memory 84 and notifies the comparator 91 of the generated read addresses while referencing the input H/V information and the input line number from the extraction timing controller 92.

The extraction timing controller 92 generates a write address in the metadata memory 85 and notifies the comparator 91 of the generated write address. As shown in FIG. 6, the write address of the metadata (M1) identified by the first extraction condition is a0. The write address of the metadata (M2) identified by the second extraction condition is a1. The write address of the metadata (M3) identified by the third extraction condition is a2. The write address of the metadata (M4) identified by the second extraction condition is a3.

In response to the timing signal from the extraction timing controller 92, the extractor 94 extracts the metadata and supplies the extracted metadata to the metadata selector and writer 95.

The metadata selector and writer 95 writes the metadata from the extractor 94 onto the write address of the metadata memory 85 generated for the metadata identified by the selection signal from the extraction timing controller 92.

More specifically, if the selection signal from the extraction timing controller 92 specifies the metadata (M1) identified by the first extraction condition set, the metadata selector and writer 95 identifies, as the address of the metadata (M1), a0 of the write addresses of which the read/write address controller 93 has notified. The metadata selector and writer 95 writes the metadata (M1) from the extractor 94 onto the address a0 of the metadata memory 85.

If the selection signal from the extraction timing controller 92 specifies the metadata (M2) identified by the second extraction condition set, the metadata selector and writer 95 identifies, as the address of the metadata (M2), a1 of the write addresses of which the read/write address controller 93 has notified. The metadata selector and writer 95 writes the metadata (M2) from the extractor 94 onto the address a1 of the metadata memory 85.

If the selection signal from the extraction timing controller 92 specifies the metadata (M3) identified by the third extraction condition set, the metadata selector and writer 95 identifies, as the address of the metadata (M3), a2 of the write addresses of which the read/write address controller 93 has notified. The metadata selector and writer 95 writes the metadata (M3) from the extractor 94 onto the address a2 of the metadata memory 85.

If the selection signal from the extraction timing controller 92 specifies the metadata (M4) identified by the fourth extraction condition set, the metadata selector and writer 95 identifies, as the address of the metadata (M4), a3 of the write addresses of which the read/write address controller 93 has notified. The metadata selector and writer 95 writes the metadata (M4) from the extractor 94 onto the address a3 of the metadata memory 85.

A process of the meta extractor 55 of FIG. 6, namely, a receiver side metadata extraction process is described below with reference to a flowchart of FIG. 7.

Process in step S21 is a setting process performed by the main controller 56 of FIG. 6.

In step S21, the main controller 56 stores (sets) each extraction condition data onto the extraction condition memories (the H_ANC/V_ANC memory 81, the line number memory 82, the DID memory 83, and the SDID memory 84).

In step S22, the read/write address controller 93 generates the read addresses.

In step S23, the comparator 91 determines whether the input signal (the input DID/SDID, input H/V information and the input line number) has been input.

If it is determined in step S23 that the input signal has not been input yet, processing proceeds to step S31. Step S31 and subsequent steps will be described later.

If it is determined in step S23 that the input signal has been input, processing proceeds to step S24. In step S24, the comparator 91 sets, as a target address, a leading read address (a0 in FIG. 4) of the read addresses (a0 through a3 in FIG. 4).

In step S25, the comparator 91 reads the extraction condition set from the target address of the extraction condition memories.

In step S26, the comparator 71 determines whether the signal information matches the extraction condition set read in the preceding step S25.

If it is determined in step S26 that the signal information matches the extraction condition set, processing proceeds to step S29. Step S29 and subsequent steps will be described later.

If it is determined in step S26 that the signal information fails to match the extraction condition set, processing proceeds to step S27. In step S27, the comparator 91 determines whether the extraction condition set at the trailing read address (a3 in FIG. 6) has been read.

If it is determined in step S27 that the extraction condition set at the trailing read address has already been read, processing proceeds to step S31. Step S31 and subsequent steps will be described later.

If it is determined in step S27 that the extraction condition set at the trailing read address has not yet been read, processing proceeds to step S28. In step S28, the comparator 91 sets a next read address as a target address. Processing returns to step S25 to perform step S25 and subsequent steps. A series of process steps performed by the comparator 91 (to successively read the extraction conditions from the memories) is a loop process composed of steps S25 through S28.

A p-th extraction condition set (p is an integer falling within a range from 1 through 4) may match the signal information. The determination in step S26 in the p-th loop process of step S25 through S38 may be yes, and processing proceeds to step S29. More precisely, through the process in step S26, the determination result that the p-th extraction condition set matches the input signal is supplied from the comparator 91 to the extraction timing controller 92. As previously described, the extraction timing controller 92 generates the selection signal specifying the selection/write of the metadata (Mp) identified by the p-th extraction condition set and the timing signal indicating the timing at which the metadata (Mp) is extracted. The extraction timing controller 92 supplies the selection signal to the metadata selector and writer 95, and the timing signal to the extractor 94. Processing proceeds to step S29.

In step S29, the extractor 94 extracts the metadata (Mp) from the input signal (more precisely, a portion of the input signal identified by the signal information input in the previous step S23), and supplies the metadata (Mp) to the metadata selector and writer 95.

In step S30, the metadata selector and writer 95 writes the metadata (Mp) onto the corresponding address of the metadata memory 85 (a(p−1) of the write addresses generated by the read/write address controller 93).

In step S31, the meta extractor 55 determines whether the input signal has been input (with the last portion thereof already input).

If it is determined in step S31 that the input signal has not been input (with the last portion thereof not yet input), processing returns to step S23 to repeat step S23 and subsequent steps.

If it is determined in step S31 that the input signal has been input (with the last portion thereof already input), the receiver side metadata extraction process ends.

The meta extractor 55 has been discussed in detail with reference to FIGS. 6 and 7.

The present invention is applicable not only to the transmission and reception system of FIG. 1 but also to a variety of transmission and reception systems.

More specifically, the present invention is applicable to a transmission and reception system including a transmitter and a receiver to be discussed below. The actual form of the transmission and reception system is not limited to any particular form.

The transmitter as one embodiment of the present invention may include a multiplexing condition storage unit configured to store a first multiplexing condition for multiplexing the first metadata into the stream data, and a second multiplexing condition for multiplexing the second metadata into the stream data, a multiplex determination unit configured to successively read from the multiplexing condition storage unit the first multiplexing condition and the second multiplexing condition in a predetermined order sequence, and successively determining in the predetermined order sequence whether a predetermined portion of the stream data satisfies one of the first multiplexing condition and the second multiplexing condition, a multiplexing unit configured to multiplex the first metadata to a portion of the stream data that the multiplex determination unit has determined as satisfying the first multiplexing condition, and for multiplexing the second metadata to a portion of the stream data that the multiplex determination unit has determined as satisfying the second multiplexing condition, and a transmitting unit configured to transmit the stream data into which the multiplexing unit has multiplexed the first metadata and the second metadata. The actual form of the transmitter is not limited to any particular one.

As long as the multiplexing condition storage unit, the multiplex determination unit, the multiplexing unit, and the transmitting unit have the above-described function, the actual form of each unit is not limited to any particular form.

The receiver as an embodiment of the present invention includes a receiving unit configured to receive the stream data, an extraction condition storage unit configured to store a first extraction condition for extracting the first metadata from the stream data and a second extraction condition for extracting the second metadata from the stream data, an extraction determination unit configured to successively read the first extraction condition and the second extraction condition in a predetermined order sequence from the extraction condition storage unit and to successively determine in the predetermined order sequence whether a predetermined portion of the stream data received by the receiving unit satisfies one of the first extraction condition and the second extraction condition, and an extracting unit configured to extract the first metadata from the portion of the stream data received by the receiving unit and determined by the extraction determination unit as satisfying the first extraction condition and extracting the second metadata from the portion of the stream data received by the receiving unit and determined by the extraction determination unit as satisfying the second extraction condition. The actual form of the receiver is not limited to any particular one.

As long as the receiving unit, the extraction condition storage unit, the extraction determination unit, and the extracting unit have the above-referenced functions, the actual form of the units is not limited to any particular form.

The first metadata and the second metadata are simply multiplexed into the stream data and are not limited to any particular form.

In the transmission and reception system of FIG. 3, not only the metadata (M1 through M4) of FIG. 4 but also DID (D1 through D4) and SDID (S1 through S4) may be considered as one form of the metadata.

For example, the audio data A multiplexed by the audio multiplexer 42 may be considered as one form of the metadata. The audio multiplexer 42 may have a design similar to that of the meta multiplexer 43 (although such an example is not shown herein). More specifically, the audio multiplexer 42 may have a multiplexing condition storage unit (memory), a multiplex determination unit, and a multiplexing unit. The audio extractor 54 corresponding to the audio multiplexer 42 may have a design similar to that of the meta extractor 55 corresponding to the meta multiplexer 43. More specifically, the audio extractor 54 may include an extraction condition storage unit (memory), an extraction determination unit, and an extracting unit.

As previously discussed, the transmitter and the receiver of embodiments of the present invention employ memories to store the multiplexing condition (data) and the extraction condition (data) and the memory-map method, the transmitter and the receiver can cope with a current increase in the number of types and the number of units of metadata. The memory outperforms the register in per area resource efficiency and even if the number of types and the number of units of metadata increase, required number of memories is not so increased as required number of registers. Since the field programmable gate array (FPGA) includes a large number of usable memories, the efficient use of the FPGAs permits high usage design.

Currently, metadata of not only a large number of types (units) but also of large data size is used, metadata of substantially increased data size can be used in future. The size of data where the metadata is multiplexed is not limitless but subject to a finite amount. In such a case, the transmitter and the receiver of embodiments of the present invention may have functions for performing the following series of steps.

In the transmitter, the data size of a portion of the stream data with which the metadata is multiplexed is defined, and one of the first metadata and the second metadata exceeds the defined data size, and is divided on a per defined data size basis into N data units (N is an integer equal to or larger than 2). One of the first multiplexing condition and the second multiplexing condition includes N units of multiplexing conditions for multiplexing the N data units with the steam data. One of the first multiplexing condition and the second multiplexing condition includes N units of multiplexing conditions and when one of the first multiplexing condition and the second multiplexing condition is to be read, the multiplex determination unit successively reads each of the N units of multiplexing conditions in a predetermined order sequence from the multiplexing condition storage unit, and determines in the order sequence whether a predetermined portion of the stream data satisfies the read unit of multiplexing condition. The multiplexing unit multiplexes each of the N data units divided from one of the first metadata and the second metadata with each of N units of the stream data that the multiplex determination unit has determined as satisfying each of the N units of multiplexing condition.

In the receiver, the data size of a portion of the stream data with which the metadata is multiplexed is defined, and one of the first metadata and the second metadata exceeds the defined data size, each of the defined data size is divided on a per defined data size basis into N data units (N is an integer equal to or larger than 2), and the N data units have been multiplexed with different portions of the stream data. One of the first extraction condition and the second extraction condition includes N units of extraction conditions for extracting the N data units from the steam data. One of the first extraction condition and the second extraction condition includes N units of extraction condition and when one of the first extraction condition and the second extraction condition is to be read, the extraction determination unit successively reads each of the N units of extraction conditions in a predetermined order sequence from the extraction condition storage unit, and determines in the order sequence whether a predetermined portion of the stream data satisfies the read unit of extraction condition. The extraction unit extracts each of the N data units divided from one of the first metadata and the second metadata from each of N units of the stream data that the extraction determination unit has determined as satisfying each of the N units of extraction conditions.

The above-described series of process steps may be performed using hardware or software. If the series of process steps is performed using software, a program forming the software may be installed from a program recording medium onto a computer built in dedicated hardware, or a general-purpose personal computer that can perform a variety of processes with a variety of programs installed thereon.

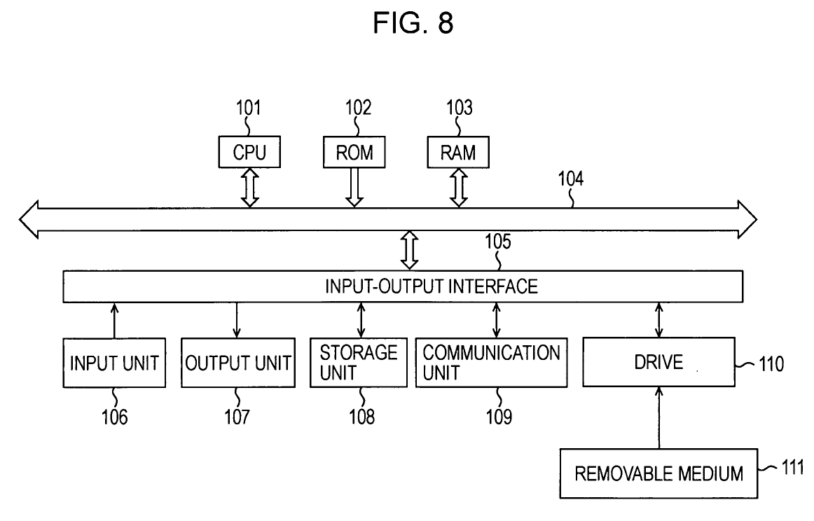

FIG. 8 is a block diagram illustrating the personal computer that is programmed to perform the series of process steps.

As shown in FIG. 8, a central processing unit (CPU) 101 performs a variety of processes under the control of a program stored on a read-only memory (ROM) 102 or a storage unit 108. A random-access memory (RAM) 103 stores programs performed by the CPU 101 or data. The CPU 101, the ROM 102, and the RAM 103 are interconnected to each other via a bus 104.

The CPU 101 also connects to an input-output interface 105 via the bus 104. Connected to the input-output interface 105 are an input unit 106 including a keyboard, a mouse, and a microphone, and an output unit 107 including a display and a loudspeaker. The CPU 101 performs a variety of processes in response to an instruction input via the input unit 106. The CPU 101 outputs the process results to the output unit 107.

The storage unit 108 connected to the input-output interface 105 includes a hard disk, for example, and stores the program performed by the CPU 101 and a variety of data. A communication unit 109 communicates with an external apparatus via a network such as the Internet or a local-area network.

The program may be acquired via the communication unit 109 and then stored onto the storage unit 108.

When a removable medium 111, such as a magnetic disk, an optical disk, a magneto-optical disk, or a semiconductor memory, is loaded onto the drive 110 connected to the input-output interface 105, the drive 110 drives the removable medium 111 and acquires the program and the data stored on the removable medium 111. The acquired program and data are transferred to the storage unit 108 for storage as necessary.

As shown in FIG. 8, the program recording media storing the program that is to be installed onto the computer for execution include the removable medium 111 as a package medium including one of a magnetic disk (including a flexible disk), an optical disk (such as compact disk read-only memory (CD-ROM)), or digital versatile disk (DVD)), a magneto-optical disk (such as mini-disk (MD®), and a semiconductor memory. The program recording medium also include the ROM 102 for temporarily or permanently storing the program or the hard disk including the storage unit 108. The storage of the program onto the program recording medium is performed by using a wired or wireless communication medium such as a local-area network, the Internet, or digital satellite broadcasting via the communication unit 109 as an interface including a router and a modem.

The process steps describing the program stored on the recording medium may be performed in the time-series order sequence as previously stated. Alternatively, the process steps may be performed in parallel or separately.

In this specification, the system refers to a plurality of apparatuses.

It should be understood by those skilled in the art that various modifications, combinations, sub-combinations and alterations may occur depending on design requirements and other factors insofar as they are within the scope of the appended claims or the equivalents thereof.

What is claimed is:

1. A transmission and reception system comprising a transmitter for transmitting stream data into which first metadata and second metadata are multiplexed, and a receiver for receiving the stream data transmitted by the transmitter and extracting the first metadata and the second metadata from the stream data,
wherein the transmitter includes:
a multiplexing condition storage unit configured to store a first multiplexing condition for multiplexing the first metadata into the stream data, and a second multiplexing condition for multiplexing the second metadata into the stream data;
a multiplex determination unit configured to successively read from the multiplexing condition storage unit the first multiplexing condition and the second multiplexing condition in a predetermined order sequence, and configured to successively determine in the predetermined order sequence whether a predetermined portion of the stream data satisfies one of the first multiplexing condition and the second multiplexing condition;
a multiplexing unit configured to multiplex the first metadata to the portion of the stream data that the multiplex determination unit has determined as satisfying the first multiplexing condition, and configured to multiplex the second metadata to the portion of the stream data that the multiplex determination unit has determined as satisfying the second multiplexing condition; and
a transmitting unit configured to transmit the stream data into which the multiplexing unit has multiplexed the first metadata and the second metadata; and
wherein the receiver includes:
a receiving unit configured to receive the stream data transmitted from the transmitter;
an extraction condition storage unit configured to store a first extraction condition for extracting the first metadata from the stream data and a second extraction condition for extracting the second metadata from the stream data;
an extraction determination unit configured to successively read the first extraction condition and the second extraction condition in a predetermined order sequence from the extraction condition storage unit and configured to successively determine in the predetermined order sequence whether a predetermined portion of the stream data received by the receiving unit satisfies one of the first extraction condition and the second extraction condition; and
an extracting unit configured to extract the first metadata from the portion of the stream data received by the receiving unit and determined by the extraction determination unit as satisfying the first extraction condition and configured to extract the second metadata from the portion of the stream data received by the receiving unit and determined by the extraction determination unit as satisfying the second extraction condition.

2. A transmission and reception method of a transmission and reception system including a transmitter for transmitting stream data into which first metadata and second metadata are multiplexed, the transmitter including at least a multiplexing condition memory storing a first multiplexing condition for multiplexing the first metadata into the stream data, and a second multiplexing condition for multiplexing the second metadata into the stream data, and a receiver for receiving the stream data transmitted from the transmitter, and extracting the first metadata and the second metadata from the stream data, the receiver including at least an extraction condition memory for storing a first extraction condition for extracting the first metadata from the stream data and a second extraction condition for extracting the second metadata from the stream data, the method comprising the steps of:
successively reading from the multiplexing condition memory the first multiplexing condition and the second multiplexing condition in a predetermined order sequence, and successively determining in the predetermined order sequence whether a predetermined portion of the stream data satisfies one of the first multiplexing condition and the second multiplexing condition;
multiplexing the first metadata to the portion of the stream data that is determined as satisfying the first multiplexing condition, and multiplexing the second metadata to the portion of the stream that is determined as satisfying the second multiplexing condition;
transmitting the stream data into which the first metadata and the second metadata have been multiplexed;
receiving the stream data transmitted from the transmitter;
successively reading the first extraction condition and the second extraction condition in a predetermined order sequence from the extraction condition memory and successively determining in the predetermined order sequence whether a predetermined portion of the received stream data satisfies one of the first extraction condition and the second extraction condition; and
extracting the first metadata from the portion of the received stream data that is determined as satisfying the first extraction condition and extracting the second metadata from the portion of the received data stream that is determined as satisfying the second extraction condition.

3. A transmitter for transmitting stream data into which first metadata and second metadata are multiplexed, the transmitter comprising:
a multiplexing condition storage unit configured to store a first multiplexing condition for multiplexing the first metadata into the stream data, and a second multiplexing condition for multiplexing the second metadata into the stream data;
a multiplex determination unit configured to successively read from the multiplexing condition storage unit the first multiplexing condition and the second multiplexing condition in a predetermined order sequence, and configured to successively determine in the predetermined order sequence whether a predetermined portion of the stream data satisfies one of the first multiplexing condition and the second multiplexing condition;
a multiplexing unit configured to multiplex the first metadata to the portion of the stream data that the multiplex determination unit has determined as satisfying the first multiplexing condition, and configured to multiplex the second metadata to the portion of the stream data that the multiplex determination unit has determined as satisfying the second multiplexing condition; and
a transmitting unit configured to transmit the stream data into which the multiplexing unit has multiplexed the first metadata and the second metadata.

4. The transmitter according to claim 3, wherein the first multiplexing condition contains information that identifies a portion of the stream data where the first metadata is predetermined to be multiplexed,
wherein the second multiplexing condition contains information that identifies a portion of the stream data where the second metadata is predetermined to be multiplexed, and
wherein the multiplex determination unit determines the predetermined portion of the stream data as satisfying the first multiplexing condition if the predetermined portion of the stream data is the portion identified by the first multiplexing condition and determines the predetermined portion of the stream data as satisfying the second multiplexing condition if the predetermined portion of the stream data is the portion identified by the second multiplexing condition.

5. The transmitter according to claim 3, wherein each of the first multiplexing condition and the second multiplexing condition includes a first type and a second type,
wherein the multiplexing condition storage unit includes a first memory for storing the first and second multiplexing conditions of the first type, and a second memory for storing the first and second multiplexing conditions of the second type,
wherein the multiplex determination unit successively reads from the multiplexing condition storage unit in the predetermined order sequence the first multiplexing conditions of the first type and the second type and the second multiplexing conditions of the first type and the second type, and successively determines in the predetermined order sequence whether the predetermined portion of the stream data satisfies the first multiplexing conditions of the first type and the second type or the second multiplexing conditions of the first type and the second type, and
wherein the multiplexing unit multiplexes the first metadata with the portion of the stream data if the multiplex determination unit determines that the portion of the stream data satisfies the first multiplexing conditions of the first type and the second type, and multiplexes the second metadata with the portion of the stream data if the multiplex determination unit determines that the portion of the stream data satisfies the second multiplexing conditions of the first type and the second type.

6. The transmitter according to claim 5, further comprising an address control unit,
wherein the address control unit sets an area of the first memory storing the first multiplexing condition of the first type to a first address, and an area of the first memory storing the second multiplexing condition of the first type to a second address,
sets an area of the second memory storing the first multiplexing condition of the second type to the first address and an area of the second memory storing the second multiplexing condition of the second type to the second address, and
notifies the multiplex determination unit of the setting content, and
wherein the multiplex determination unit reads from the multiplexing condition storage unit the first multiplexing conditions of the first type and the second type or the second multiplexing conditions of the first type and the second type in accordance with the setting content of which the address control unit has notified the multiplex determination unit.

7. The transmitter according to claim 3, further comprising:
a memory unit configured to store the first metadata and the second metadata; and
a metadata reading unit configured to read the first metadata from the memory unit if the multiplex determination unit has determined that the first multiplexing condition is satisfied, and configured to read the second metadata from the memory unit if the multiplex determination unit has determined that the second multiplexing condition is satisfied,
wherein the multiplexing unit multiplexes the first metadata read by the metadata reading unit with the portion of the stream data that the multiplex determination unit has determined as satisfying the first multiplexing condition, and multiplexes the second metadata read by the metadata reading unit with the portion of the stream data that the multiplex determination unit has determined as satisfying the second multiplexing condition.

8. The transmitter according to claim 3, wherein the data size of a portion of the stream data with which the metadata is multiplexed is defined, and one of the first metadata and the second metadata exceeds the defined data size, and is divided on a per defined data size basis into N data units (N is an integer equal to or larger than 2),
wherein one of the first multiplexing condition and the second multiplexing condition includes N units of multiplexing conditions for multiplexing the N data units with the steam data,
wherein one of the first multiplexing condition and the second multiplexing condition includes the N units of multiplexing conditions and when one of the first multiplexing condition and the second multiplexing condition is to be read, the multiplex determination unit successively reads each of the N units of multiplexing conditions in a predetermined order sequence from the multiplexing condition storage unit, and determines in the order sequence whether a predetermined portion of the stream data satisfies the read unit of multiplexing condition, and
wherein the multiplexing unit multiplexes each of the N data units divided from one of the first metadata and the second metadata with each of N units of the stream data that the multiplex determination unit has determined as satisfying each of the N units of multiplexing condition.

9. A transmitting method of a transmitter for transmitting stream data into which first metadata and second metadata are multiplexed, the transmitter including at least a memory for storing a first multiplexing condition for multiplexing the first metadata into the stream data, and a second multiplexing condition for multiplexing the second metadata into the stream data, the method comprising the steps of:
prior to transmitting the stream data into which the first metadata and the second metadata are multiplexed,
successively reading the first multiplexing condition and the second multiplexing condition from the memory in a predetermined order sequence, and determining in the predetermined order sequence whether a predetermined portion of the stream data satisfies one of the first multiplexing condition and the second multiplexing condition; and
multiplexing the first metadata with the portion of the stream data that is determined as satisfying the first multiplexing condition, and multiplexing the second metadata with the portion of the stream that is determined as satisfying the second multiplexing condition.

10. A program for causing a computer to control an apparatus for transmitting stream data into which first metadata and second metadata are multiplexed, the apparatus including at least a memory for storing a first multiplexing condition for multiplexing the first metadata into the stream data, and a second multiplexing condition for multiplexing the second metadata into the stream data, the program comprising the steps of:
prior to transmitting the stream data into which the first metadata and the second metadata are multiplexed,
successively reading the first multiplexing condition and the second multiplexing condition from the memory in a predetermined order sequence, and determining in the predetermined order sequence whether a predetermined portion of the stream data satisfies one of the first multiplexing condition and the second multiplexing condition; and
multiplexing the first metadata with the portion of the stream data that is determined as satisfying the first multiplexing condition, and multiplexing the second metadata with the portion of the stream that is determined as satisfying the second multiplexing condition.

11. A receiver for receiving stream data into which first metadata and second metadata are multiplexed, and extracting the first metadata and the second metadata from the stream data, the receiver comprising:
a receiving unit configured to receive the stream data;
an extraction condition storage unit configured to store a first extraction condition for extracting the first metadata from the stream data and a second extraction condition for extracting the second metadata from the stream data;
an extraction determination unit configured to successively read the first extraction condition and the second extraction condition in a predetermined order sequence from the extraction condition storage unit and configured to successively determine in the predetermined order sequence whether a predetermined portion of the stream data received by the receiving unit satisfies one of the first extraction condition and the second extraction condition; and
an extracting unit configured to extract the first metadata from the portion of the stream data received by the receiving unit and determined by the extraction determination unit as satisfying the first extraction condition and configured to extract the second metadata from the portion of the stream data received by the receiving unit and determined by the extraction determination unit as satisfying the second extraction condition.

12. The receiver according to claim 11, wherein the first extraction condition contains information that identifies a portion of the stream data where the first metadata is predetermined to be multiplexed,
wherein the second extraction condition contains information that identifies a portion of the stream data where the second metadata is predetermined to be multiplexed, and
wherein the extraction determination unit determines a predetermined portion of the stream data received by the receiving unit as satisfying the first extraction condition if the predetermined portion of the stream data is the portion identified by the first extraction condition and determines the predetermined portion of the stream data as satisfying the second extraction condition if the predetermined portion of the stream data is the portion identified by the second extraction condition.

13. The receiver according to claim 11, wherein each of the first extraction condition and the second extraction condition includes a first type and a second type,
wherein the extraction condition storage unit includes a first memory for storing the first and second extraction conditions of the first type, and a second memory for storing the first and second extraction conditions of the second type,
wherein the extraction determination unit successively reads from the extraction condition storage unit in the predetermined order sequence the first extraction conditions of the first type and the second type and the second extraction conditions of the first type and the second type, and successively determines in the predetermined order sequence whether the predetermined portion of the stream data satisfies the first extraction conditions of the first type and the second type or the second extraction conditions of the first type and the second type, and
wherein the extracting unit extracts the first metadata from the portion of the stream data that the extraction determination unit determines as satisfying the first extraction conditions of the first type and the second type, and extracts the second metadata from the portion of the stream data that the extraction determination unit determines as satisfying the second extraction conditions of the first type and the second type.

14. The receiver according to claim 13, further comprising an address control unit,
wherein the address control unit sets an area of the first memory storing the first extraction condition of the first type to a first address, and an area of the first memory storing the second extraction condition of the first type to a second address,
sets an area of the second memory storing the first extraction condition of the second type to the first address and an area of the second memory storing the second extraction condition of the second type to the second address, and
notifies the extraction determination unit of the setting content, and
wherein the extraction determination unit reads from the extraction condition storage unit one of the first extraction conditions of the first type and the second type or the second extraction conditions of the first type and the second type in accordance with the setting content of which the address control unit has notified the extraction determination unit.

15. The receiver according to claim 11, further comprising:
a memory unit configured to store the first metadata and the second metadata; and
a metadata writing unit configured to write one of the first metadata and the second metadata extracted by the extracting unit onto the memory unit.

16. The receiver according to claim 11, wherein the data size of a portion of the stream data with which the metadata is multiplexed is defined, and one of the first metadata and the second metadata exceeds the defined data size, and is divided on a per defined data basis into N data units (N is an integer equal to or larger than 2), and the N data units have been multiplexed with different portions of the stream data,
wherein one of the first extraction condition and the second extraction condition includes N units of extraction conditions for extracting the N data units from the steam data,
wherein one of the first extraction condition and the second extraction condition includes N units of extraction conditions and when one of the first extraction condition and the second extraction condition is to be read, the extraction determination unit successively reads each of the N units of extraction conditions in a predetermined order sequence from the extraction condition storage unit, and determines in the order sequence whether a predetermined portion of the stream data satisfies the read unit of extraction condition, and
wherein the extraction unit extracts each of the N data units divided from one of the first metadata and the second metadata from each of the N units of the stream data that the extraction determination unit has determined as satisfying each of N units of extraction condition.

17. A receiving method of a receiver for receiving stream data into which first metadata and second metadata are multiplexed, and extracting the first metadata and the second metadata from the stream data, the receiver including at least a memory for storing a first extraction condition for extracting the first metadata from the stream data, and a second extraction condition for extracting the second metadata from the stream data, the method comprising the steps of:
successively reading the first extraction condition and the second extraction condition from the memory in a predetermined order sequence, and determining in the predetermined order sequence whether a predetermined portion of the stream data received by the receiver satisfies one of the first extraction condition and the second extraction condition; and
extracting the first metadata from the portion of the stream data received by the receiver and determined as satisfying the first extraction condition, and extracting the second metadata from the portion of the stream data received by the receiver and determined as satisfying the second extraction condition.

18. A program for causing a computer to control an apparatus for receiving stream data into which first metadata and second metadata are multiplexed, and extracting the first metadata and the second metadata from the stream data, the apparatus including at least a memory for storing a first extraction condition for extracting the first metadata from the stream data, and a second extraction condition for extracting the second metadata from the stream data, the program comprising the steps of:
successively reading the first extraction condition and the second extraction condition from the memory in a predetermined order sequence, and determining in the predetermined order sequence whether a predetermined portion of the stream data received by the apparatus satisfies one of the first extraction condition and the second extraction condition; and
extracting the first metadata from the portion of the stream data received by the apparatus and determined as satisfying the first extraction condition, and extracting the second metadata from the portion of the stream data received by the apparatus and determined as satisfying the second extraction condition.
